(19) United States
(12) Patent Application Publication
(10) Pub. No.: US 2007/0063992 A1
(43) Pub. Date: Mar. 22, 2007

(54) Finger-keyed human-machine interface device

(76) Inventor: Paul Bryan Lundquist, Tucson, AZ (US)

Correspondence Address: LAW OFFICE OF TIMOTHY M. BARLOW, P.O. BOX 523272, SPRINGFIELD, VA, 22152, US

(21) Appl. No.: 11/228,647

(22) Filed: Sep. 17, 2005

(51) Int. Cl. G09G 5/00

(52) U.S. Cl. 345/174; 345/168

(57) ABSTRACT

A finger-keyed human-machine interface device and methods provide outputs suitable for entering keyed data into a computer, cash register, musical device or other machines. Varying relative positions or orientations of body-attached electrodes generates data. Combinations of connections between electrodes are translated into output signals corresponding to keyed outputs. Levels of connections are used for predictive provisional inputs allowing a user to retract outputs before they are made final and for other applications. Mappings of electrodes attached to fingers and hands are presented for entering keyed data or selecting musical notes.

### BACKGROUND

1. Technological Field

This invention is in the field of human-machine interface devices.

2. Discussion of the Related Art

Many types of communication with computers or other electronic equipment requires data entry using more than one finger. For example, one of the most important data input devices for a computer is a keyboard. Other examples include keypads, musical keyboards, phone buttons, cash registers, and other multi-keyed or multi-buttoned devices. Operationally, the computer keyboard hasn't progressed much since it was adapted from typewriters. As computer and electronics devices are being increasingly miniaturized to enhance mobility, keyboards have become one of the technological components that resists miniaturization more than others.

An effective keyboard needs to have buttons or keys that are spaced at distances that are at least as large as typical fingers. One of the approaches for reducing keyboard sizes has been to decrease the number of keys. This can be achieved by increasing the number of letters or functions represented by a single key. For example, cell-phone keypads typically allow for text editing by allowing letters to be accessed if a key is pressed repeatedly within a short period of time. Computer keyboards and calculator keypads have added functionality by including control and function keys that, when pressed prior to pressing other keys, provide additional meanings for other keys. Even with these improvements, keyboards and keypads still require a substantial proportion of volume for many electronic devices.

One of the constraints for keyboard or keypad data entry is that it requires a point of reference. For example, if a user's fingers are off by a key, typing becomes gibberish. This may become an additional barrier for interaction with a computer for those who are visually impaired. Additionally, keyboards and keypads require some physical positioning relative to the device for efficient data entry and cannot be efficiently used while moving. Data entry during the course of work for many active occupations is disruptive.

### SUMMARY

The invention includes methods and systems for entering data into electronic devices. Data signal are generated or transmitted based on sensed electrical coupling between body-attached electrodes positioned on various body parts. Movement of the different body parts into close proximity, or contact generate signals associated with connections between electrodes. This invention is primarily related to the input of keyed data into a computer by positioning electrodes attached to a person's hands and/or fingers. However, this invention extends beyond this single application.

Connections between electrodes may be through conductive transfer of electrical current, capacitive coupling between electrodes, or inductive coupling between electrodes. A collection of electrodes form a reconfigurable electrical connection network, where connections between electrodes may be sensed by one or more output generating device. An output generating element or elements may be used to sense and process an electrical connection network configuration and produce output signals simulating keypad or keyboard inputs for a computer or other machine. Output signals, or an intermediate set of signals based on a network configuration or state may be sent through wireless communications to another electronic device (e.g. a computer). Wireless communications may be encrypted for certain applications.

This invention has many advantages over existing keyboard devices. Since data entry is performed though connecting body parts, the device can be used while in motion and doesn't require a stationary horizontal surface for supporting the device. For embodiments using electrodes on fingers and hands, motions for connecting electrodes may be smaller and more natural than standard keyboard entry. The human hand is designed to bring fingers together as is necessary for grasping and picking things up, but the motions required for typing are less natural. Data entry through connecting electrodes on fingers and hands may make it easier to enter data at a rapid speed and may make repetitive motion injuries less likely.

Since the invention requires very little volume it is ideal for integration with small personal electronic devices. For example, the device could easily be integrated with a small text to speech device that might allow those who are unable to speak to still produce voice communication. Additionally a personal text to translated voice device might be made practical using the portable-keying device described herein.

For electrode connections based on capacitive coupling, connections between electrodes may be sensed by probe voltages being applied sequentially to the electrodes. On applications of the probe voltage, other electrodes may be monitored for voltage changes. The same technique may also be used for electrically conductive electrode connections. Connections between inductively coupled electrodes may also be achieved by successively applying a small current to each electrode and sensing induced signals on other electrodes.

Because different portions of a reconfigurable network of electrodes may be attached to parts of the body that are widely separated (for example, a user's left hand and right hand), it may be necessary for multiple local output generating devices to be used to sense a reconfigurable network. Output generating devices may be connected to a separate cluster of electrodes within a reconfigurable network. Probe signals used for connection sensing in clusters may be designed so that a probe signal generated for an electrode in one cluster may be detected on an electrode that is part of a separate cluster. For example, if two clusters are for a left hand and right hand respectively, probe signals for a right hand and left hand may have opposite polarity. If two or more clusters are required, probe pulse lengths may be used to identify which electrode is providing a probe signal. Clustering of electrodes is particularly useful when output-generating elements communicate to other electrical devices using wireless communications because it eliminates the need for a wired connection between different portions of a network. However, the wireless communications may need to be able to support synchronization of probe pulses for multiple disconnected electrode clusters. For example, if two clusters handle left and right hands respectively, probe pulses from the clusters may need to be alternated, and identification of source electrodes may need to be calculated from synchronized timing.

In some embodiments, electrodes are attached to different portions of fingers and/or hands. However, electrodes may be attached to any body parts having sufficient dexterity for manipulation. A disabled person who doesn't have sufficient dexterity in their fingers may use other parts of their body (for example, electrodes attached to arms, legs, feed, or chin).

Electrical connections between electrodes may be direct electrical connections in which current flows from one electrode into one or more other electrode(s). This electrical coupling is established when physical contact is made between electrodes. Electrical coupling may also be established by physical contact between the flesh of two body parts, where the electrodes provide small amounts of current into the body parts.

Electrical connections between the electrodes may be established through capacitive coupling, where a physical contact between the electrodes is not required. This has advantages in that electrodes may be protected by a covering of dielectric material. Furthermore, a signal may be sensed as the electrodes approach each other. This variable proximity sensing may be used for additional output signals.

Similar advantages may be obtained through inductive coupling between electrodes, where current probe pulses are provided to source electrodes having small coils, and small coils on sensing electrodes receive inductively sourced electromotive force voltages.

As sensors detect approaching electrodes, before a full connection is established, predictive signals may be sent to an electronic device. An electronic device may be configured to provide feedback to a user so that keying errors may be avoided. This is particularly useful while learning to use a device.

In some embodiments, electrodes are attached to fingers and/or hands through a wearable glove. A glove for attaching electrodes to hands and fingers may be consistent with other specific advantages. For example, in sterile environments, it may be disadvantageous for multiple people to share the same input device, but it may be impractical for each individual to have separate keyboards sitting on tables. Instead, a single electronic device could be controlled from multiple wireless gloved systems of body attached electrodes. This may be especially useful in medical and food preparation environments.

In other embodiments, electrodes are attached to fingers and/or hands by a support system that may be more easily attached or released from a hand. In either case, additional electronic input devices may be attached to a glove or mechanical support system. For example, a cursor control device may be attached to the back of one or more hands so that both traditional functions of a keyboard and mouse may be performed with a single hands-free device.

### BRIEF DESCRIPTION OF THE DRAWINGS

FIG. 1 shows positioning of body-attached electrodes to a hand and fingers in one embodiment of the invention.

FIG. 2 shows an embodiment of the invention, from the electrode side, where a support system attaches body-attached electrodes to portions of a persons fingers and hands, in one embodiment of the invention.

FIG. 3 shows an embodiment of the invention, from the back side, where a support system attaches body-attached electrodes to portions of a persons fingers and hands, in one embodiment of the invention.

FIG. 4 illustrates body-attached electrodes attached to fingers and hands using a glove, in one embodiment of the invention.

FIG. 5A-D shows schematics of a reconfigurable electrode network with four electrodes as different electrodes are probed and sensed, in one embodiment of the invention.

FIG. 6 shows an embodiment of the invention where an additional electrode is attached to a separate device instead of being body-attached, in one embodiment of the invention.

FIG. 7 shows a cross-section of capacitive coupling electrodes attached to two fingers, in one exemplary embodiment of the invention.

FIG. 8A-B Shows cross-sections of conductive coupling electrodes attached to two fingers, in one exemplary embodiment of the invention.

FIG. 9A shows a cross-section of inductive coupling electrodes attached to two fingers, in one exemplary embodiment of the invention.

FIG. 9B shows the placement of inductive coupling electrode coils on one finger in one embodiment of the invention, in one exemplary embodiment of the invention.

FIG. 10 shows finger and hand positions for connecting electrodes in one embodiment of the invention, in one exemplary embodiment of the invention.

FIG. 11 shows an example of a finger and hand position generating an electrode network configuration with simultaneous connections between multiple pairs of electrodes, in one exemplary embodiment of the invention.

FIG. 12 shows an example of a finger and hand position generating an electrode network configuration with simultaneous connections between multiple pairs of electrodes, including connections involving at least one electrode from both hands, in one exemplary embodiment of the invention.

FIG. 13 shows an example of a finger and hand position generating an electrode network configuration with a multi-connect connection, where at least one electrode in a connection is connected with more than one other electrode.

FIG. 14A-B are tables that shows how different electrode connections for a left hand and right hand are mapped to basic keys of a keyboard, in one exemplary embodiment of the invention.

FIG. 15 is a table that shows how different electrode connections are mapped to keys of a keyboard with edit functions, in one exemplary embodiment of the invention.

FIG. 16 is a table that shows how different electrode connections are mapped to keypad keys of a keyboard, in one exemplary embodiment of the invention.

FIG. 17 is a table that shows how different electrode connections are mapped to symbol keys of a keyboard, in one exemplary embodiment of the invention.

FIG. 18 is a table that shows how different electrode connections are mapped to function keys of a keyboard, in one exemplary embodiment of the invention.

FIG. 19 is a table showing mappings of left-handed electrodes to overtone selections and mappings of right-hand electrode connections, including multi-connect connections, to pitch-lowering selections in an exemplary musical embodiment of the invention.

FIG. A-C Illustrate digitization of a signal connection to provide levels of a connection, in one exemplary embodiment of the invention.

FIG. 21A-C Illustrate the use of levels of connection to provide a user with predictive feedback, and use of predictive feedback to avoid keying errors, in one exemplary embodiment of the invention.

FIG. 22 illustrating exemplary process elements of a process for keying inputs using body-attached electrodes, in one exemplary embodiment of the invention.

FIG. 23 illustrates exemplary process elements of a process for sensing connections between body attached electrodes, in one exemplary embodiment of the invention.

FIG. 24 illustrates exemplary process elements of a process for providing a user with predictive feedback, in one exemplary embodiment of the invention.

### DETAILED DESCRIPTION OF THE DRAWINGS

While the invention is susceptible to various modifications and alternate forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope and spirit of the invention as defined by the claims.

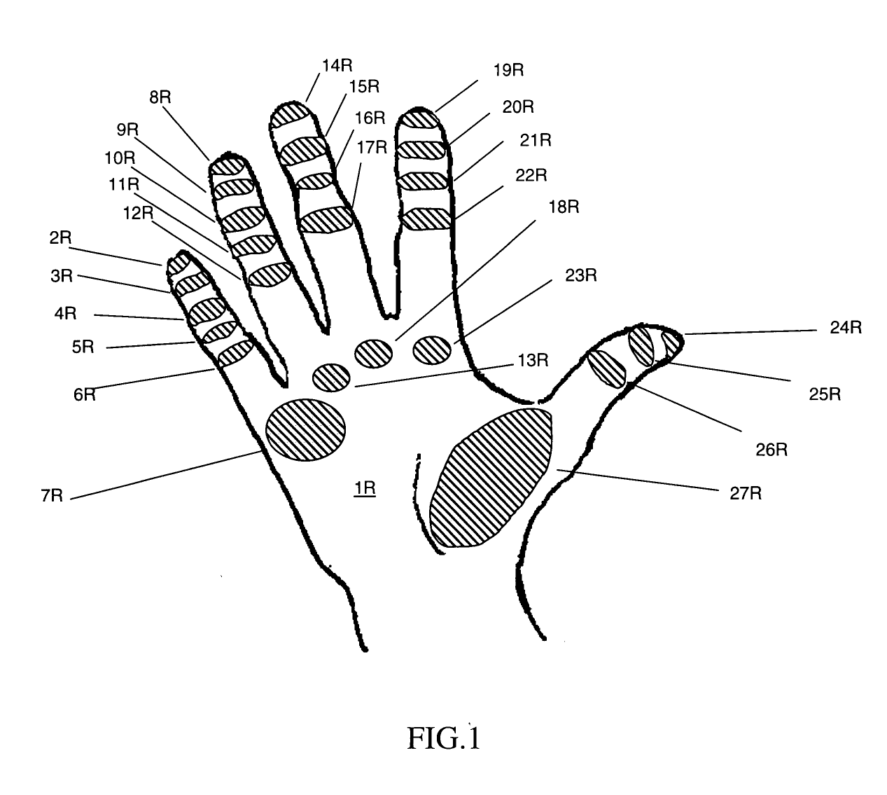

FIG. 1 shows an embodiment of the invention with 26 body-attached electrodes attached to a person's right hand 1R. In this embodiment, electrodes are attached to each finger, including a thumb, a palm of the hand and regions on a hand and below the little, ring, middle and index fingers. For such an embodiment, electrodes may be labeled using a convenient notation shown in Table 1 below. Electrodes are labeled in FIG. 1, and are referenced by number in the first column of Table 1. A notation for referring to electrodes is defined in the second column of Table 1. The region of the hand and position within that region where each electrode is attached to a hand is defined in the third and fourth column, respectively.

TABLE 1

| Electrode | Notation | Region | Position |
|---|---|---|---|
| 2R | R5.1 | Right Little Finger | Finger Tip |
| 3R | R5.2 | Right Little Finger | 1^{st} down from finger tip |
| 4R | R5.3 | Right Little Finger | 2^{nd} down from finger tip |
| 5R | R5.4 | Right Little Finger | 3^{rd} down from finger tip |
| 6R | R5.5 | Right Little Finger | 4^{th} down from finger tip |
| 7R | R5.K | Right Little Finger | Hand below little finger |
| 8R | R4.1 | Right Ring finger | Finger Tip |
| 9R | R4.2 | Right Ring finger | 1^{st} down from finger tip |
| 10R | R4.3 | Right Ring finger | 2^{nd} down from finger tip |
| 11R | R4.4 | Right Ring finger | 3^{rd} down from finger tip |
| 12R | R4.5 | Right Ring finger | 4^{th} down from finger tip |
| 13R | R4.K | Right Ring finger | Hand below Ring Finger |
| 14R | R3.1 | Right Middle finger | Finger Tip |
| 15R | R3.2 | Right Middle finger | 1^{st} down from finger tip |
| 16R | R3.3 | Right Middle finger | 2^{nd} down from finger tip |
| 17R | R3.4 | Right Middle finger | 3^{rd} down from finger tip |
| 18R | R3.K | Right Middle finger | Hand below Middle Finger |
| 19R | R2.1 | Right Index finger | Finger Tip |
| 20R | R2.2 | Right Index finger | 1^{st} down from finger tip |
| 21R | R2.3 | Right Index finger | 2^{nd} down from finger tip |
| 22R | R2.4 | Right Index finger | 3^{rd} down from finger tip |
| 23R | R2.K | Right Index finger | Hand below Index Finger |
| 24R | R1.1 | Right Thumb | Finger Tip |
| 25R | R1.2 | Right Thumb | 1^{st} down from finger tip |
| 26R | R1.3 | Right Thumb | 2^{nd} down from finger tip |
| 27R | R1.K | Right Thumb | Palm |

Using the notation scheme defined in Table 1, the first letter identifying an electrode may be either ‘R’ or ‘L’ to indicate whether the electrode is on the right side of the body or left side of the body. The number that follows the letter code indicates on which finger the electrode is attached. For example: the number “1” indicates a thumb, the number “2” indicates an index finger, the number “3” indicates a middle finger, the number “4” indicates a ring finger, and the number “5” indicates the little finger. The character after the decimal point indicates the relative position of the electrode on the region defined by the code to the left of the decimal point. For example, the letter ‘K’ refers to a portion of the hand below a finger, or a number may be used as an index to the electrodes on a given finger. One skilled in the art should readily recognize that the invention is not limited to the electrodes indicated in Table 1. Electrodes may be used on both hands, or other body parts and a notation may be defined to appropriately describe any such set of electrodes.

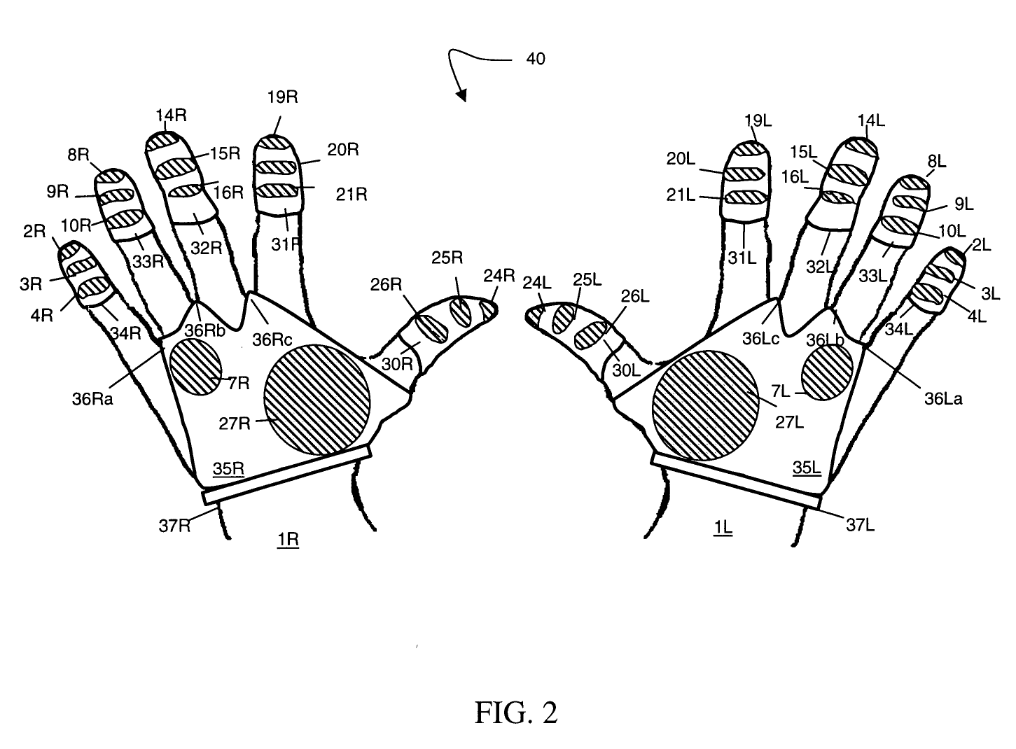

In one exemplary embodiment, illustrated in FIG. 2, electrodes may be attached to a person's right hand 1R and left hand 1L and fingers using a strap-on support system 40. A plurality of finger socks may be used to attach electrodes to fingers. For example, hands 1L and 1R are shown with finger socks attaching electrodes using thumb finger socks 30R and 30L with attaching electrodes 24R, 25R, 26R, on right hand 1R, and 24L, 25L, and 26L, on left hand 1L; index finger socks 31R and 31L attaching electrodes 19R, 20R, 21R, on right hand 1R, and 19L, 20L, 21L on left hand 1L; middle finger socks 32R and 32L attaching electrodes 14R, 15R, 16R on right hand 1R, and electrodes 14L, 15L, 16L on left hand 1L; ring finger socks 33R and 33L attaching electrodes 8R, 9R, 1OR on right hand 1R, and electrodes 8L, 9L, 10L on left hand 1L; and little finger socks 34R and 34L attaching electrodes 2R, 3R, 4R on right hand 1R, and 2L, 3L, 4L on left hand 1L.

Additional electrodes may be attached to hands using attachment structures with straps or hooks that pass from the front of the hand between the fingers. Furthermore, attachment structures may be attached using a cuff strap attaching an attachment structure to the base of the hand. For example, FIG. 2 illustrates electrode 7L and electrode 27L attached to a left hand 1L using a palm-support structure 35L that is attached to the hand using inter-finger straps 36La, 36Lb and 36Lc, that pass between fingers, and a cuff strap 37L which secures palm-support structure 35L to base of hand 1L. Likewise, the illustration shows electrode 7R and electrode 27R attached to a right hand 1R using a palm-support structure 35R that is attached to the hand using inter-finger straps 36Ra, 36Rb and 36Rc, that pass between fingers, and a cuff strap 37R which secures palm-support structure 35R to base of hand 1R.

One skilled in the art should readily recognize that straps for holding attachment structures to hands may be designed to pass between different fingers in many different arrangements and may be either rigid or flexible. Furthermore, cuff straps, 37R or 37L, may be either rigid, flexible, or effectively substituted by a restricted shape of a palm support structure, 35R or 35L, so as to wrap around the lower portion of a hand or wrist.

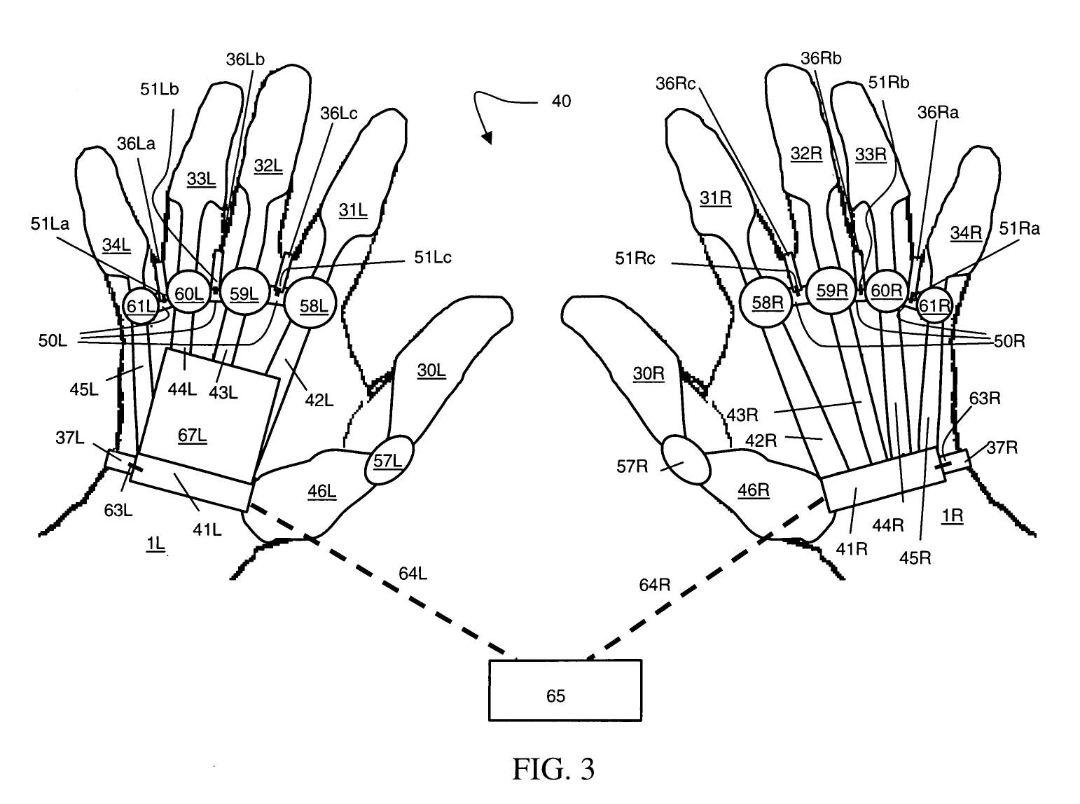

FIG. 3. shows a strap-on support system 40 and a persons left hand 1L and right hand 1R, from above. On a left hand 1L, finger socks 31L, 32L, 33L, and 34L may be attached to a local output generating device 41L through connecting straps 42L, 43L, 44L, and 45L, respectively. Additionally, finger sock 30L may be attached to a local output generating device 41L through thumb-support structure 46L, which may be attached to, or be part of palm-support structure 35L (shown in FIG. 2). Attachments to output generating device 41L may also include electrical attachments for transferring electrical signals.

Likewise, on a right hand 1R, finger socks 31R, 32R, 33R, and 34R may be attached to a local output generating device 41R through connecting straps 42R, 43R, 44R, and 45R, respectively. Additionally, finger sock 30R may be attached to a local output generating device 41R through thumb-support structure 46R, which may be attached to, or be part of palm-support structure 35R (shown in FIG. 2). Attachments to output generating device 41R may also include electrical attachments for transferring electrical signals.

On the right hand, inter-finger support straps 37Ra, 37Rb, and 37Rc, may also be used to palm-support structure 35R (shown in FIG. 2) to a knuckle strap 50R using quick connects 51Ra, 51Rb, and 51Rc respectively. The quick-connects 51Ra, 51Rb, and 51Rc may be designed for quick connection and release using any number of clasping mechanisms. Likewise, for the left hand, inter-finger support straps 37La, 37Lb, and 37Lc, may also be used to palm-support structure 35L (shown in FIG. 2) to a knuckle-strap 50L using quick-connects 51La, 51Lb, and 51Lc respectively. Quick-connects may be replaced with permanent connections, and inter-finger support straps may be constructed with elastic material so that strap-on support system 40 be quickly put on or taken off.

On a right hand, 1R, knuckle-protects 58R, 59R, 60R and 61R may be used to disperse forces on hand from the motion-related stress from knuckle strap 50R and connecting straps 42R, 43R, 44R and 45R. Additionally, knuckle-protect 57R may be used to disperse the forces on a thumb knuckle from tensions from palm-support structure 35R (shown in FIG. 2), connecting strap 46R, and finger sock 30R. Knuckle-protects 57R, 58R, 59R, 60R, and 61R further serve a purpose of protecting repeatedly flexed portions of strap-on support system 40 from damage due to wear.

Likewise, for a left hand, 1L, knuckle-protects 58L, 59L, 60L and 61L may be used to disperse forces on hand from the motion related stress from knuckle strap 50L and connecting straps 42L, 43L, 44L and 45L. Additionally, knuckle-protect 57L may be used to disperse the forces on a thumb knuckle from tensions from palm-support structure 35L (shown in FIG. 2), connecting strap 46L, and finger sock 30L. Knuckle-protects 57L, 58L, 59L, 60L, and 61L further serve a purpose of protecting repeatedly flexed portions of strap-on support system 40 from damage due to wear.

Cuff straps 37L (or 37R) may attach palm-support structure 35L (or 35R) to local output generating device 41L (or 41R) using a cuff quick-connection 63L (or 63R). Alternatively, cuff strap 37L (or 37R) may constructed using elastic material so as to allow a hand 1L (or 1R) to fit through cuff strap 37L (or 37R) but remain secured when strap-on support system 40 is worn.

Local output generating devices, 41R and 41L may communicate with an output generating device 65. Communications transfer 64 between local output generating devices 41R and 41L and output generating device 65 may be performed through wired or wireless communications. Communications transfer 64 may include encrypted data for security.

Additional elements may be attached to the backs of hands. For example, an additional element 67L may be attached to local output generating device 41L which may include an input generating device for generating cursor motion on a computer. Examples may include a capacitive sensing array, such as a touchpad (commonly used on laptop computers). An additional element 67L may also have printed instructions for use of the strap-on system 40 to help remember how to perform various input functions.

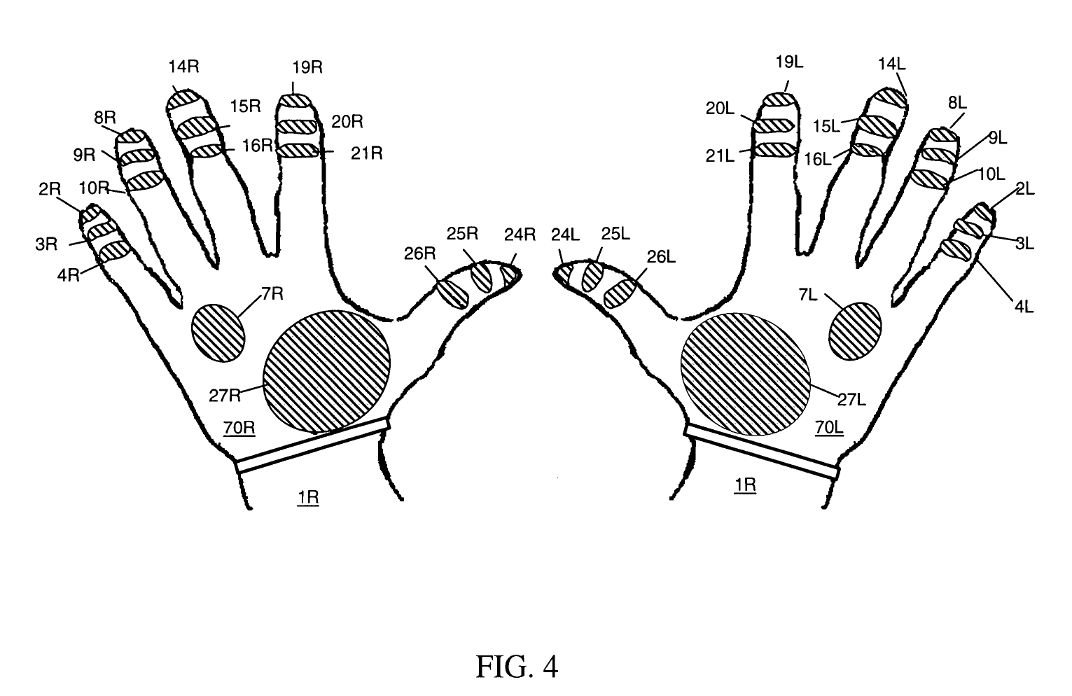

An alternative method for attaching electrodes to a person's hands is shown in FIG. 4. A glove may be used to attach electrodes to fingers and hands. In this embodiment, electrodes may be attached to the left hand 1L using a glove 70L and electrodes may be attached to the right hand 1R using a glove 70R. A glove may be simpler to manufacture than a support system and may have advantages where gloves are already used (i.e. in food service industry or medical industry where sanitation is important).

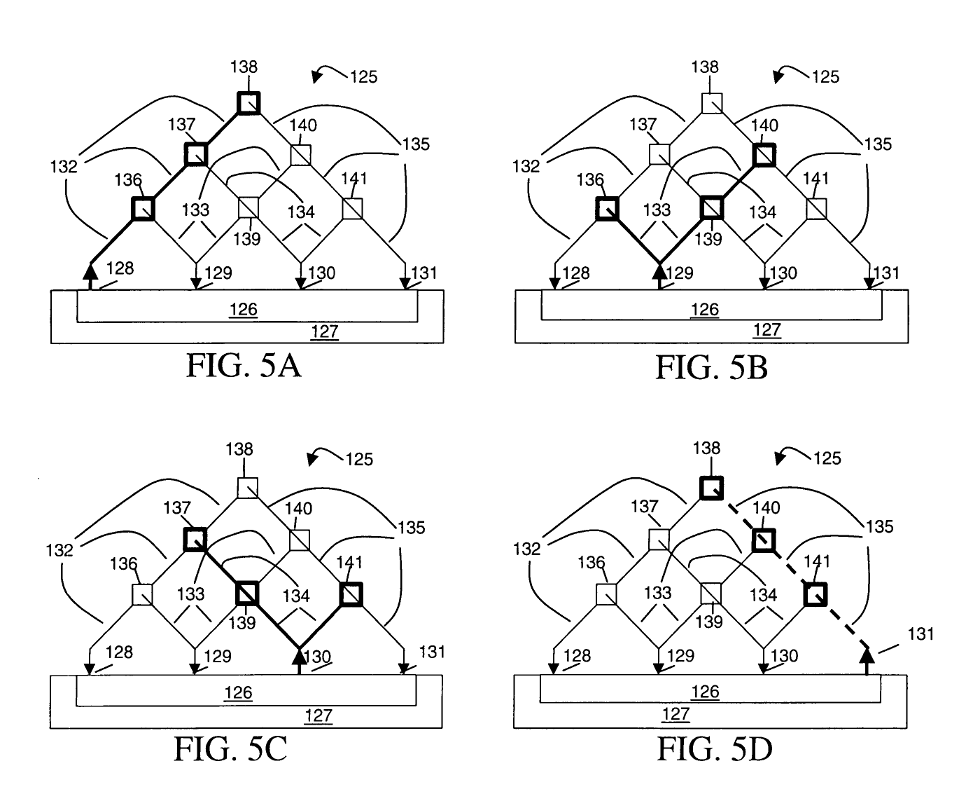

In an exemplary embodiment, FIGS. 5A, 5B, 5C, and 5D illustrate how a set of body attached electrodes may form an electrical connection network and how the connections may be sensed using multiple probe signal in electrical connection network 125. In FIGS. 5A, 5B, 5C, and 5D, electrodes are represented by 132, 133, 134, and 135; electrical connections between electrodes are represented by 136, 137, 138, 139, 140, and 141.

FIG. 5A shows an electrical connection network 125 in a specific probing configuration. An output-generating device 127 comprising an electrical connection sensor 126 with multiple reconfigurable input/output ports 128, 129, 130, and 131. Port 128 is configured to provide an electrical output signal to an electrode 132 generated by electrical connection sensor 126. Port 129 is configured to sense input signals from electrode 133; port 130 is configured to sense input signals from electrode 134; and port 131 is configured to sense input signals from electrode 135. In the configuration illustrated in FIG. 5A, port 129 may sense connection 136 between electrode 132 and electrode 133; port 130 may sense connection 137 between electrode 132 and electrode 134; and port 131 may sense connection 138 between electrode 132 and electrode 135. Connection sensor 126 may process input signals from input ports 129,130, and 131 to determine the strength or level of connection for connections 136, 137, and 138.

In FIG. 5B, the device illustrated in FIG. 5A is reconfigured so that port 129 becomes an output port providing a signal to electrode 133, and port 128 becomes an input port receiving signals from electrode 132. Electrical connections 136, 139, and 140 between electrode 133 and electrodes 132, 134, and 135 provide electrical inputs to input ports, 128,130, and 131 respectively. Connection sensor 126 may determine the strength or level of connection for connections 136, 139 and 140.

In FIG. 5C, the device illustrated in FIG. 5B is reconfigured so that port 130 becomes an output port providing a signal to electrode 134, and port 129 becomes an input port receiving signals from electrode 133. Electrical connections 137, 139, and 141 between electrode 134 and electrodes 132, 133, and 135 provide electrical inputs to input ports, 128, 129, and 131 respectively. Connection sensor 126 may determine the strength or level of connection for connections 137, 139 and 141.

In FIG. 5D, the device illustrated in FIG. 5C is so reconfigured so that port 131 becomes an output port providing a signal to electrode 135, and port 130 becomes an input port receiving signals from electrode 134. Electrical connections 138, 140, and 141 between electrode 135 and electrodes 132, 133, and 134 provide electrical inputs to input ports, 128, 129, and 130 respectively. Connection sensor 126 may determine the strength or level of connection for connections 138, 140 and 141.

The configurations illustrated in FIGS. 5A, 5B, and 5C, may be used in a sensing sequence to sense any of the connections of the electrical connection network. There is redundancy between the connections that may be sensed in each configuration of electrical connection network 125. For example, connection 136 may be sensed both in the configuration illustrated in FIG. 5A and the configuration illustrated in FIG. 5B. All connections that may be sensed in the configuration illustrated in FIG. 5D, 138, 140, and 141, may be sensed using the configurations illustrated in FIGS. 5A, 5B, and 5C. Consequently, a sensing sequence of configurations for electrical connection network 125, may, for example, omit the configuration illustrated in FIG. 5D and still sense all connections.

It should be recognized by one skilled in the art that the ports 128, 129, 130, and 131 may be either a single reconfigurable port or each may consist of two distinct input and output ports. Likewise, electrodes 132, 133, 134, and 135 may each be distinct single electrodes or consist of two electrodes optimized for input and output.

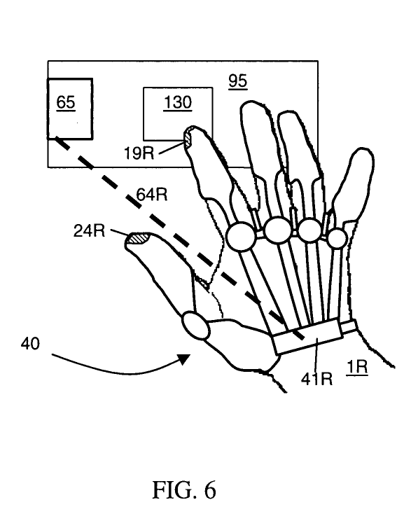

Electrodes forming an electrode configuration network make include both body-attached electrodes and electrodes that are not attached to a body. For example, in one embodiment illustrated in FIG. 6, an electrode configuration network includes electrodes that are attached to a strap-on support system 40 on a hand 1R and an electrode or electrode array 130 that is connected to a device 95. Connection strengths between body-attached electrodes 19R and 24R can be controlled as well as the connection strengths between electrode or electrode array 130 and body-attached electrodes 19R or 24R. A sensing sequence that coordinates the probing and sending of body-attached electrodes that are electrically coupled to a local output generating device 41R and the electrode or electrode array 130 may be coordinated by output generating device 65. Communications between the output generating device 65, on device 95, and the local output generating device 41R may be wireless and coordinated by synchronization of signals to the local output generating device 41R and electrode or electrode array 130.

It should readily be recognized by one skilled in the art that more than one electrode or electrode array may be attached to an output generating device and that body attached electrodes, attached to parts of the body other than or in addition to the right hand 1R, may be used.

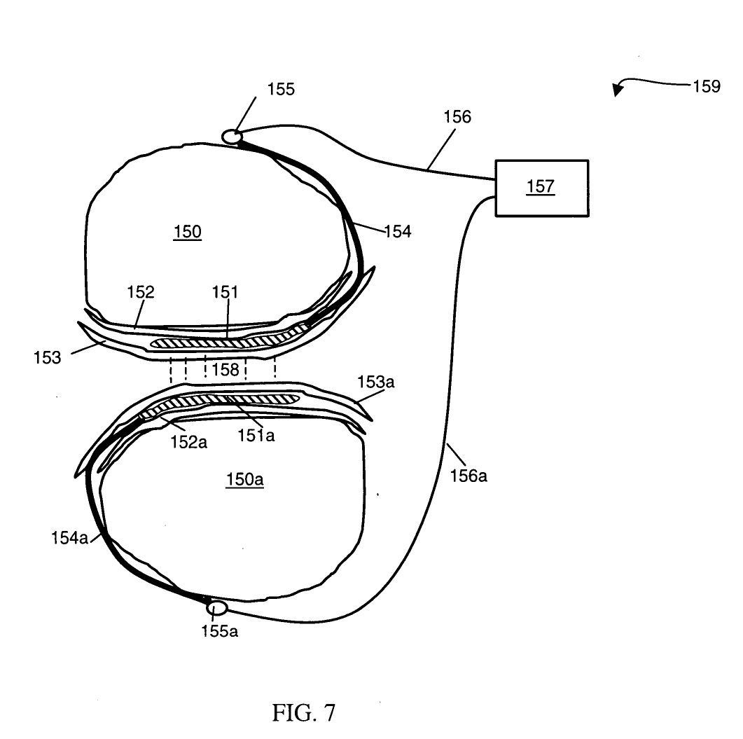

Electrodes may include many different methods for establishing an electrical connection. FIG. 7 illustrates an embodiment where an electrical connection is established between two electrodes through capacitive coupling. The illustration is a cross-section of two fingers with attached electrodes 151 and 151a. As relative positioning between first a finger 150 and a second finger 150a changes, capacitance 158 between electrode 151 and 151a also changes. An electrical probe pulse is delivered from local output generating device 157 through a cable 156. A wire coupling device 155, which may be as simple as an electrical cable, transmits the signal to a location on the back of a first finger 150 in the proximity of a first electrode 151. An electrical cable 154 transmits the signal to a first electrode 151 on the front of a finger 150. A first finger 150 may have an insulating protective layer 152 between a first electrode 151 and first finger 150 to keep the first electrode 151 from making contact with first finger 150. An insulating layer 153 may cover first electrode 151 so that it can not make a conductive connection to any other electrode.

Likewise, a second electrode 151a may be covered with an insulating layer 153a to avoid a conductive connection. Second electrode 151a may be insulated from the finger by an insulating protective layer 152a. An electric pulse delivering a voltage to first electrode 151 may capacitively induce a voltage on second electrode 151a. The capacitively induced voltage on second electrode 151a may be sensed by output generating device 157 through electric cable 154a, wire coupling device 155a and cable 156a.

The roles of electrode 151 and 151a may be reversed, if the probe pulse is delivered to 151a and the capacitively induced voltage on 151 is sensed. It may be desirable to include amplifiers within wire coupling device 155 and 155a for amplifying capacitively induced signals. In such a case cables 156 and 156a may need to provide power for the amplifiers. Amplifiers may easily be constructed using operational amplifier circuits well understood by those skilled in the art.

Insulating layers 153 and 153a protect output-generating device 157 from inadvertent connection with other conducting or charged material that could put excessive loads on electrical circuitry.

To avoid noise interference with the capacitively coupled signal, cables 156, 156a, electric cable 154 and 154a may be constructed with shielded or coaxial cabling. Furthermore, wires may be arranged so that they do not come in close proximity for longer lengths. For example, electrical cables 154 or 154a may be arranged to loop around fingers on the same side of each finger so that cables of adjacent fingers do not pass each other between fingers.

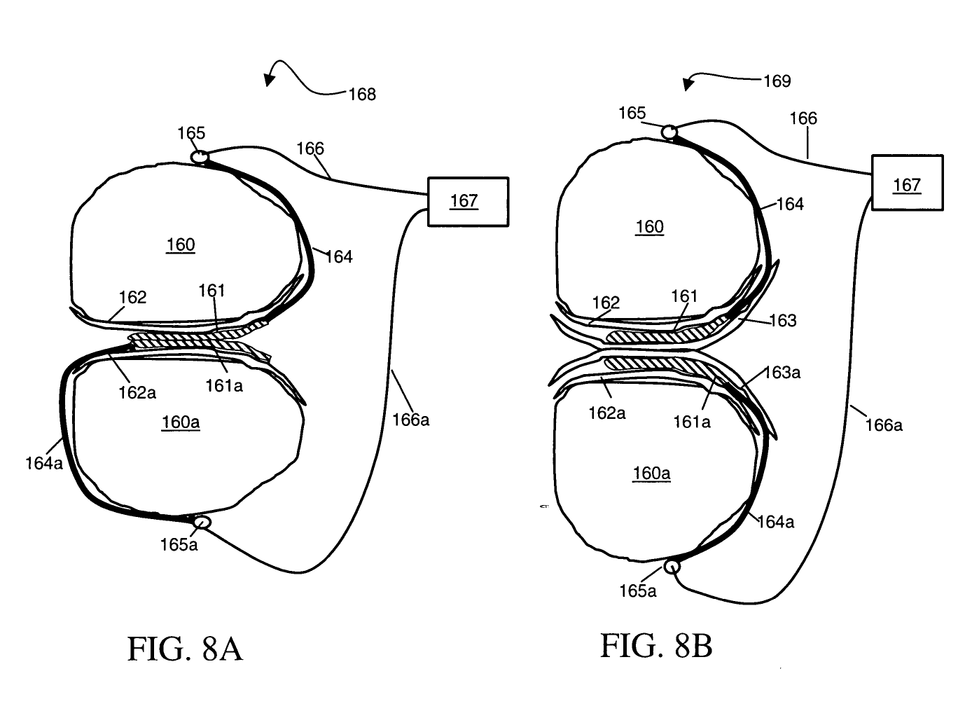

FIGS. 8A and 8B show embodiments 168 and 169, respectively, in which electrical coupling between electrodes is established through conductive connections. Output generating device 167 may either sense or probe electrodes 161 and 161a. In FIG. 8A, electrodes 161 and 161a may be brought into direct contact by placing fingers 160 and 161a close together. Direct contact between electrodes 161 and 161a may allow a probe pulse from output generating device 167 to pass from the probed electrode to the sensed electrode so that an output generating device 167 may detect a connection. An optional protective layer 162 or 162a may protect the finger from electrodes and provide additional support for electrodes. Cabling 164, 164a, 166, 166a and wire coupling device 165 and 165a all serve the purpose of transmitting signals to and from the electrodes 161 and 161a.

FIG. 8B, additionally includes a resistive layers 163a and 163b, that, when brought into contact by fingers 160 and 160a, allow current to pass between electrodes 161 and 161a. Resistive layers may have resistivities that are dependent on pressure, so that the voltage that is transmitted to the sensing electrode may be dependent on the force with which fingers are brought together. Resistive layers may be constructed, for example using piezo-resistive materials or conductive foams.

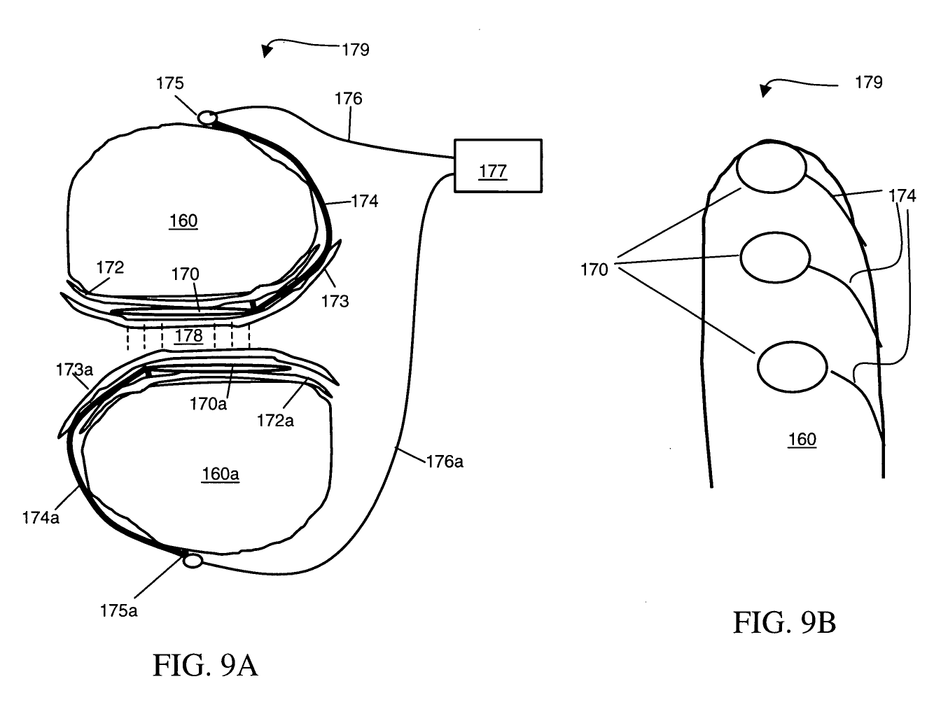

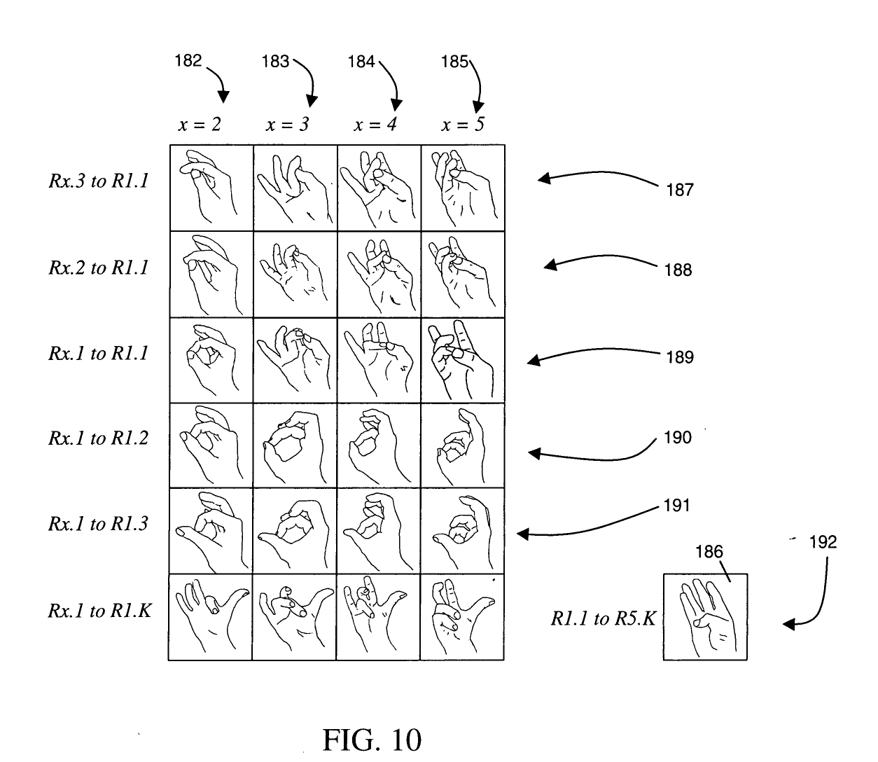

FIGS. 9A and 9B show an embodiment where electrical connections between electrodes are established through inductive coupling. In this embodiment, 179, output generating device 177 generates a current which is provided to a probed coil electrode 170. Current, progressing through coil electrode 170 generates a magnetic flux 178, and induces a voltage in a sensing coil electrode 170a placed in close proximity to the probed electrode 170. Protective layers 172, 172a, 173, and 173a may be used to protect electrodes 170 and 170a from damage and to assist in holding electrodes to a fingers 160 and 160a. FIG. 9B, shows how multiple coil electrodes may be positioned along a single finger 160. Cabling 174, 174a, 176, 176a and wire coupling device 175 and 175a all serve the purpose of transmitting signals to and from the electrode coils 170 and 170a.

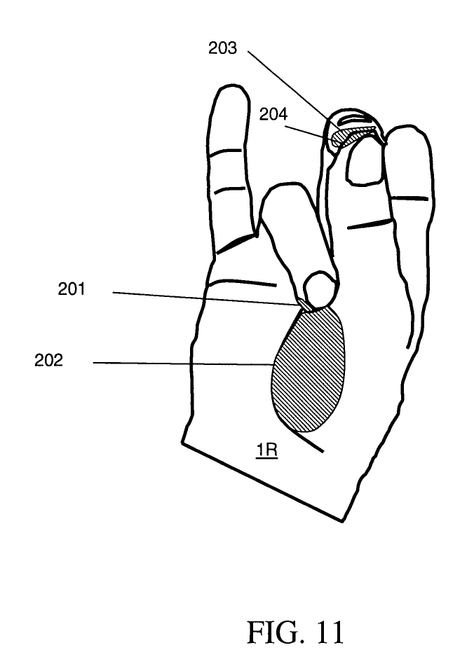

FIG. 10 is a table illustrating right hand positions for connections of electrodes named in Table 1. The first 5 rows, 187, 188, 189, 190, and 191 of illustrations correspond to electrode connections between one electrode on a thumb and one electrode on another finger that corresponds to the columns of the table (182, 183, 184, 185). The sixth row 192 corresponds to connections involving electrodes on a palm or a connection 186 between an electrode on a thumb and an electrode just under the ring or little finger (R5.K). Though many other electrode positionings and hand orientations may be used as well, the hand positions illustrated in FIG. 10, when used with both the left and right hands, are sufficient for reproducing keyboard inputs from a standard computer keyboard.

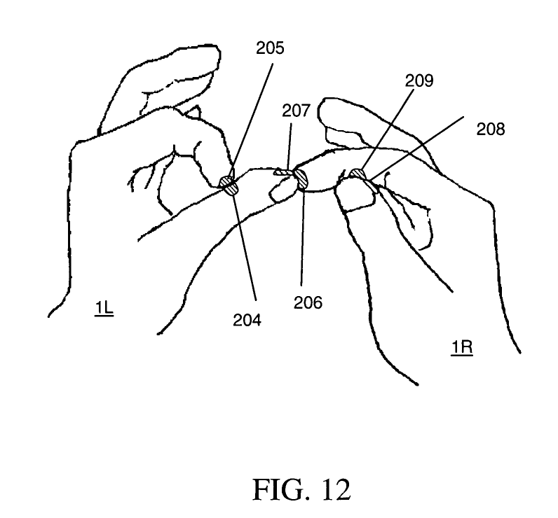

FIG. 11 illustrates an example of a simultaneous-connect connection, using a right hand 1R, where multiple electrodes form connections at the same time. For example, as shown in FIG. 11, electrode R3.1 203 may be connected to electrode R1.1 204 at the same time that electrode R4.1 201 is connected to electrode R1.K 202. Of course, many other combinations are possible. By detecting combinations of connections, many more inputs may be recognized than would be recognized in a system recognizing only one connection at a time.

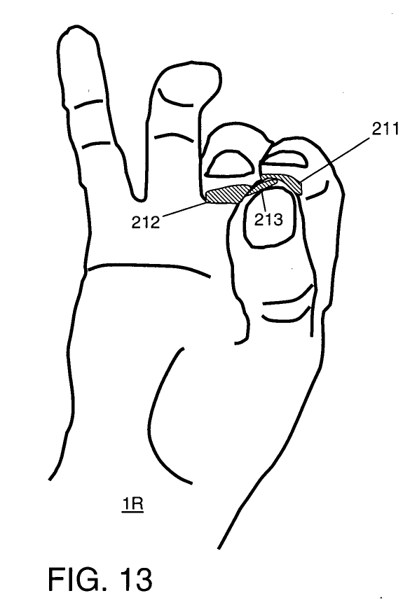

FIG. 12 shows an example connection configuration that involves a connection utilizing electrodes from both hands, as well as a connection involving only electrodes from the left hand, and a connection involving electrodes only from the right hand. A connection is established between electrodes R2.1 206 and L1.1 207 occurring simultaneously with a connection on the left hand between electrodes L1.2 204 and L2.1 205 and with a connection on the right hand between electrodes R1.1 208 and R2.2 209. Connections between electrodes from both hands may allow for more possible inputs with fewer electrodes.

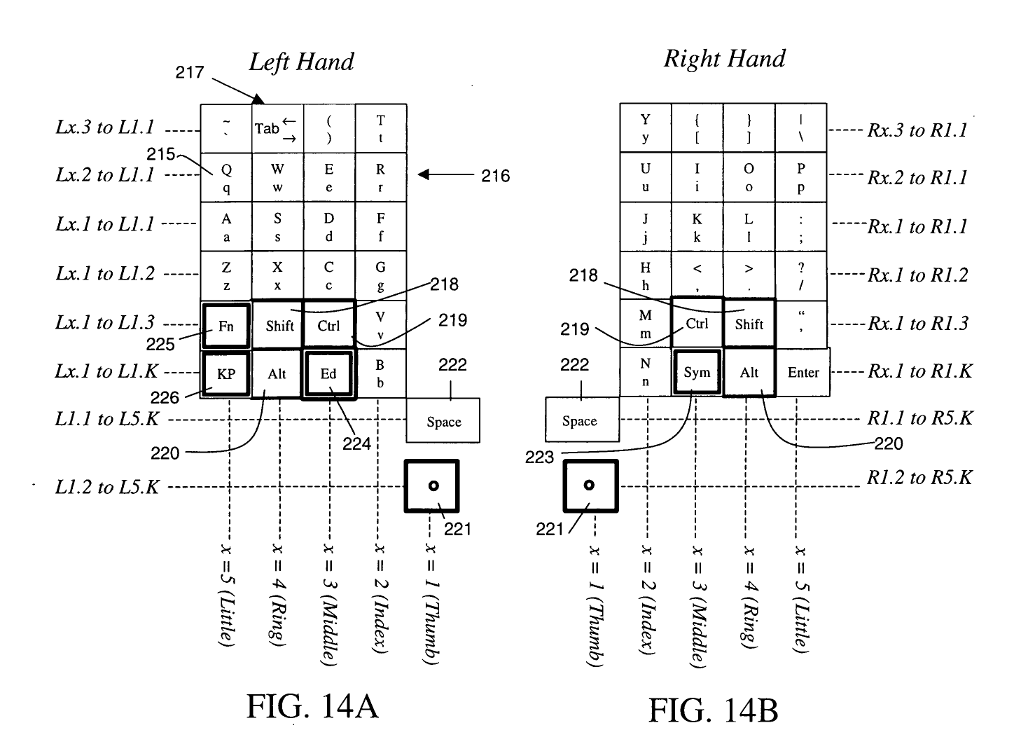

FIG. 13 illustrates a multi-connect connection where multiple electrodes are involved in one connection. An embodiment, which senses multi-connection connections, may generate far more outputs for the same number of electrodes. For example, as illustrated in FIG. 13, an electrode R2.1 211, electrode R3.1 212, and electrode R1.1 213 may be making mutual connections, where at least two connections are detected involving one electrode.

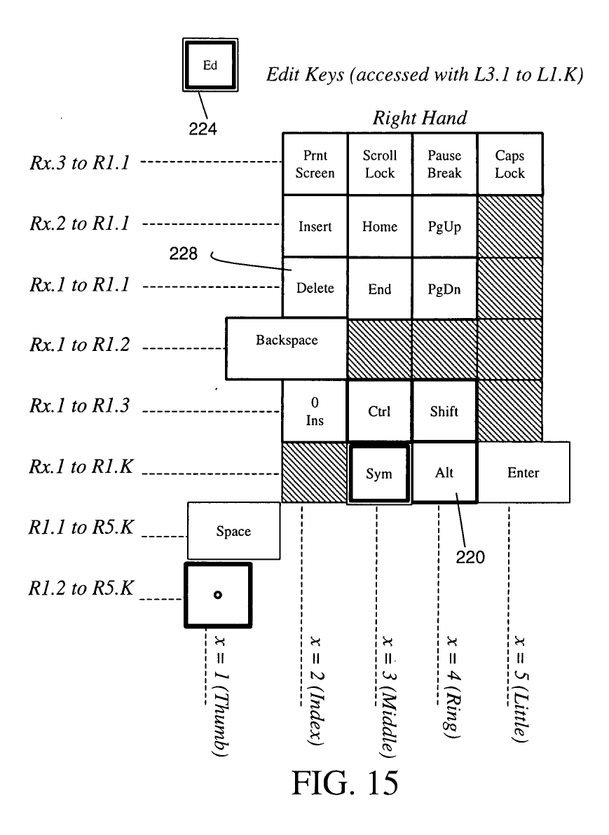

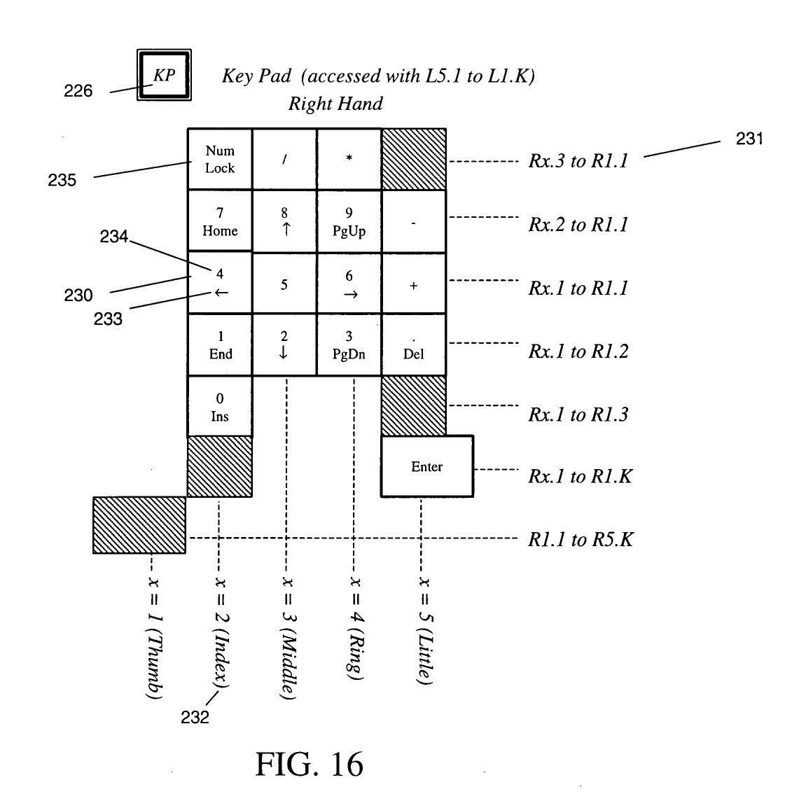

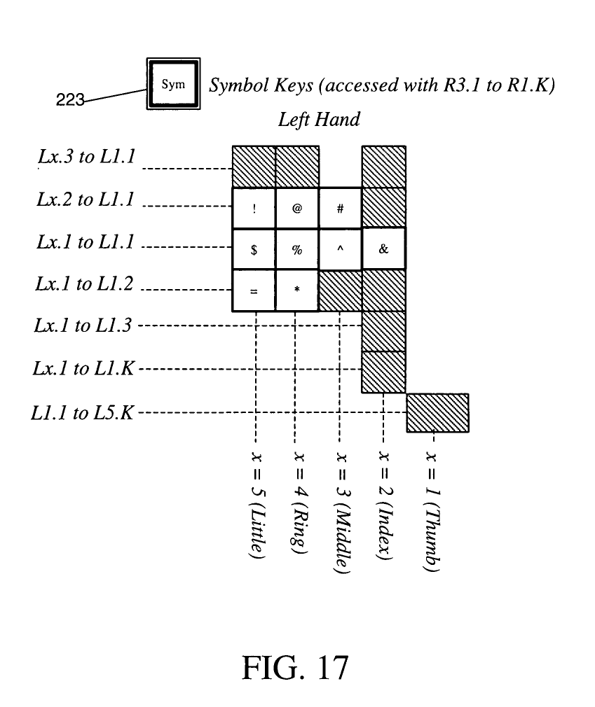

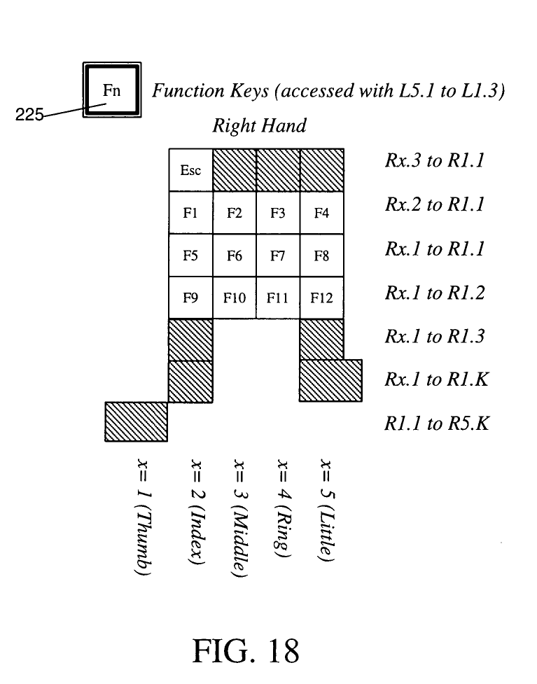

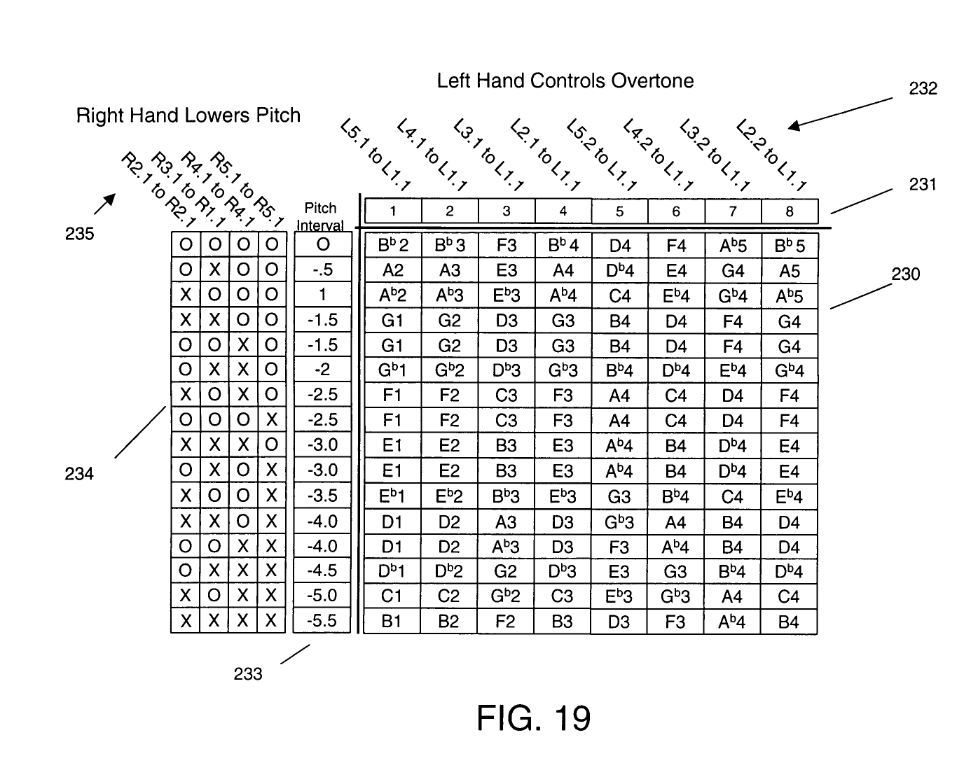

FIG. 14A and FIG. 14B are tables illustrating a mapping from electrode connections to keyboard outputs in an exemplary embodiment. In FIG. 14A, a table for inputs keys generated by a left hand is shown, and in FIG. 14B, a table for inputs keys from a right hand is shown. Keys, in the table having two characters or inputs in a column normally provide an input corresponding to the lower character in the key. For example, a key 215, corresponding to a connection ‘L5.2 to L1.1’ is indicated in row 216 labeled by “Lx.2 to L1.1” and in column 216 labeled by “x=5 (Little)”. Similar tables are used to illustrate keys selected by various connections in FIG. 15, FIG. 16, FIG. 17, and FIG. 18. In FIG. 14A, key 215 shows a letter ‘Q’ above and a lower case ‘q’ below, and as indicated by its position in the table of FIG. 14A, key 215 may be accessed by establishing an electrode connection between electrodes L5.2 and L1.1. Normally a connection between L5.2 and L1.1 may generate an output corresponding to a lower case ‘q’, but if a shift key 218 is simultaneously selected an output corresponding to an upper case ‘Q’ will be generated. In general, if a key is selected while electrodes are simultaneously connected to select a shift key 218, using either a left hand as illustrated in FIG. 14A or a right hand as illustrated in FIG. 14B, an upper case character or upper illustrated character or function in any other selected key, if available, may be accessed.

Several other special keys which may alter outputs of other keys are shown in the tables illustrated in FIGS. 14A-B. A ‘Ctrl’ key 219 may be accessed using either the right or left hand with connections R3.1 to R1.3 or L3.1 to L1.3; or, a connection with L3.1 to L1.K or R3.1 to R1.K may be used to access an ‘Alt’ key 220. Just as with a normal keyboard, these keys may be accessed to give an altered meaning for other keys that are accessed. ‘Ctrl’ key 219, ‘Alt’ keys 220, and ‘Shift’ keys 218 may be accessed using either hand so that either hand may be free to access keys with altered meaning. An additional special key 221, accessible through connection L1.2 to LK.5 or connection R1.2 to RK.5 may be used for operating system specific functions (e.g. a ‘Windows’ key for windows operating system). Space keys 222 are also accessible using electrodes from either hand to correspond to usual typing techniques. Additional special keys, accessible using left hand electrodes, including a ‘Fn’ key 225, ‘KP’ key 226, and ‘Ed’ key 224. These keys 224-226 provide altered meanings for function, keypad, and edit keys that are accessed with a right hand. Some text symbols typically accessible on a standard keyboard may be accessed using a left hand when a right hand selects a symbol key 223 by providing an a connection R3.1 to R1.K. The layout of the tables illustrated in FIGS. 14A-B show a correspondence between a mapping of finger connections to a layout of a traditional keyboard device.

Table 2 below provides similar information as presented in FIGS. 14A-B in a more typically formatted table:

TABLE 2

| Connection | Key | Key with Shift |
|---|---|---|
| L5.3 to L1.1 | ' | ˜ |
| L4.3 to L1.1 | Tab right | Tab left |
| L3.3 to L1.1 | ) | ( |
| L2.3 to L1.1 | t | T |
| L5.2 to L1.1 | q | Q |
| L4.2 to L1.1 | w | W |
| L3.2 to L1.1 | e | E |
| L2.2 to L1.1 | r | R |
| L5.1 to L1.1 | a | A |
| L4.2 to L1.1 | s | S |
| L3.2 to L1.1 | d | D |
| L2.2 to L1.1 | f | F |
| L5.1 to L1.2 | z | Z |
| L4.1 to L1.2 | x | X |
| L3.1 to L1.2 | c | C |
| L4.1 to L1.2 | g | G |
| L5.1 to L1.3 | Fn | Fn |
| L4.1 to L1.3 | Shift | Shift |
| L3.1 to L1.3 | Ctrl | Ctrl |
| L4.1 to L1.3 | v | V |
| L5.1 to L1.K | KP | KP |
| L4.1 to L1.K | Alt | Alt |
| L3.1 to L1.K | Ed | Ed |
| L4.1 to L1.K | b | B |
| L1.1 to L5.K | Space | Space |
| L1.2 to L5.K | OS | OS |
| R5.3 to R1.1 | \ | \| |
| R4.3 to R1.1 | ] | } |
| R3.3 to R1.1 | [ | { |
| R2.3 to R1.1 | y | Y |
| R5.2 to R1.1 | p | P |
| R4.2 to R1.1 | o | O |
| R3.2 to R1.1 | i | I |
| R2.2 to R1.1 | u | U |
| R5.1 to R1.1 | ; | : |
| R4.2 to R1.1 | l | L |
| R3.2 to R1.1 | k | K |
| R2.2 to R1.1 | j | J |
| R5.1 to R1.2 | / | ? |
| R4.1 to R1.2 | . | > |
| R3.1 to R1.2 | , | < |
| R4.1 to R1.2 | h | H |
| R5.1 to R1.3 | ‘ | “ |
| R4.1 to R1.3 | Shift | Shift |
| R3.1 to R1.3 | Ctrl | Ctrl |
| R4.1 to R1.3 | m | M |
| R5.1 to R1.K | Enter | Enter |
| R4.1 to R1.K | Alt | Alt |
| R3.1 to R1.K | Sym | Sym |
| R4.1 to R1.K | n | N |
| R1.1 to R5.K | Space | Space |
| R1.2 to R5.K | OS | OS |

FIG. 15 is a table showing edit keys that may be accessed by establishing connections between electrodes on a right hand while simultaneously sustaining an established connection L3.1 to L1.K, corresponding to an ‘Ed’ 224 key, using a left hand. Hashed regions in the table represent keys that may not have specific functions, or may be programmed to have other functions. Some keys, for example the ‘Ctrl’, ‘Shift’, ‘Sym’, and ‘Alt’ keys may have the same function whether the Edit key function is selected or not. On Microsoft Windows™ operating systems, the simultaneous selection of ‘Ctrl’, ‘Alt’, and ‘Delete’ keys has special functional significance. Because multiple simultaneous connections may be required to access the ‘Delete’ key, a selection of ‘Alt’ and ‘Delete’ keys may be used to simulate the ‘Ctrl’-‘Alt’-‘Delete’ function of a typical personal computer keyboard. This ‘Ctrl’-‘Alt’-‘Delete’ function may be accessed by three simultaneous connections. For example, in the present embodiment, connections ‘L3.1 to L1.K’ and ‘R2.1 to R1.1’ may be established to select a ‘Delete’ key 228, while simultaneously establishing a connection ‘R4.1 to R1.K’ to select an ‘Alt’ Key 220. Alternatively, a separate key or key-sequence may be mapped to provide the ‘Ctrl’-‘Alt’-‘Delete’ function. The layout of the table, illustrated in FIG. 15, shows a correspondence between a mapping of finger connections to a layout of a traditional keyboard device. Table 3 below provides similar information in a more typically formatted table:

TABLE 3
Edit Keys

| Connections | Key |
|---|---|
| L3.1 to L1.K and R5.3 to R1.1 | Caps Lock |
| L3.1 to L1.K and R4.3 to R1.1 | Pause/Break |
| L3.1 to L1.K and R3.3 to R1.1 | Scroll Lock |
| L3.1 to L1.K and R2.3 to R1.1 | Print Screen |
| L3.1 to L1.K and R4.2 to R1.1 | Page Up |
| L3.1 to L1.K and R3.2 to R1.1 | Home |
| L3.1 to L1.K and R2.2 to R1.1 | Insert |
| L3.1 to L1.K and R4.1 to R1.1 | Page Down |
| L3.1 to L1.K and R3.1 to R1.1 | End |
| L3.1 to L1.K and R2.1 to R1.1 | Delete |
| L3.1 to L1.K and R2.1 to R1.2 | Backspace |
| L3.1 to L1.K and R4.1 to R1.3 | Shift |
| L3.1 to L1.K and R3.1 to R1.3 | Ctrl |
| L3.1 to L1.K and R2.1 to R1.3 | Insert |
| L3.1 to L1.K and R5.1 to R1.K | Enter |
| L3.1 to L1.K and R4.1 to R1.K | Alt |
| L3.1 to L1.K and R3.1 to R1.K | Sym |
| L3.1 to L1.K and R1.1 to R4.K | Space |
| L3.1 to L1.K and R1.2 to R4.K | OS |

FIG. 16 is a table showing keypad keys that may be accessed using a right hand while connection L5.1 to L1.K, corresponding to a ‘KP’ key 226, is sustained using a left hand. As in many typical keypads on computer keyboards, keys may have a set of functions that are operative when a ‘Num Lock’ mode is entered, and a normal set of functions that are operative otherwise. Keys, in FIG. 16 having two characters or inputs in a column normally provide an input corresponding to the lower character in the key. For example, a key 230 is indicated in row 231 labeled by “Rx.3 to R1.1” and in column 232 labeled by “x=2 (Index)”. Key 230 shows a character ‘4’ 234 above and a left arrow symbol 233 below. As indicated by its position in the table of FIG. 16, key 230 may be accessed by establishing an electrode connection between electrodes R2.3 and R1.1. When a ‘Num Lock’ mode is active and Key Pad keys are made available through a connection ‘L5.1 to L1.K’, a simultaneous connection between R2.3 and R1.1 may generate an output corresponding to a character ‘4’ 234, but if an a ‘Num Lock’ mode is inactive, key 230 generates an output corresponding to a left arrow symbol 233. In general, if a Key Pad key is selected while a ‘Num Lock’ mode is active, an upper character, if available, as illustrated in FIG. 16, will be selected. If only one character is illustrated on a key of FIG. 16, outputs corresponding to that character may be outputted regardless of the ‘Num Lock’ mode. Alternatively, some keys may be made to be selectable only if a ‘Num Lock mode’ is active, or inactive.

Key 235, shown in FIG. 16, corresponds to the function of toggling a ‘Num Lock’ mode. By selecting key 235, a user may activate a ‘Num Lock’ mode if it is inactive, or inactivate a ‘Num Lock’ mode that is already active. Key 235 may be selected by simultaneously establishing a connection ‘L5.1 to L1.K’ with a left hand and a connection ‘R2.3 to R1.1’ with a right hand.

The layout of the table, illustrated in FIG. 16, shows a correspondence between a mapping of finger connections to a layout of a traditional keyboard device. Table 4, below, provides much of the same information in a more typically formatted table:

TABLE 4
Keypad Keys

| | Key | Key |
|---|---|---|
| Connections | (Num Lock Off) | (Num Lock On) |
| L5.1 to L1.K and R2.3 to R1.1 | Num Lock | Num Lock |
| | Toggle | Toggle |
| L5.1 to L1.K and R3.3 to R1.1 | / | / |
| L5.1 to L1.K and R4.3 to R1.1 | * | * |
| L5.1 to L1.K and R2.2 to R1.1 | Home | 7 |
| L5.1 to L1.K and R3.2 to R1.1 | Cursor Up | 8 |
| L5.1 to L1.K and R4.2 to R1.1 | Page Up | 9 |
| L5.1 to L1.K and R5.2 to R1.1 | - | - |
| L5.1 to L1.K and R2.1 to R1.1 | Cursor Left | 4 |
| L5.1 to L1.K and R3.1 to R1.1 | | 5 |
| L5.1 to L1.K and R4.1 to R1.1 | Cursor Right | 6 |
| L5.1 to L1.K and R5.1 to R1.1 | + | + |
| L5.1 to L1.K and R2.1 to R1.2 | End | 1 |
| L5.1 to L1.K and R3.1 to R1.2 | Cursor Down | 2 |
| L5.1 to L1.K and R4.1 to R1.2 | Page Down | 3 |
| L5.1 to L1.K and R5.1 to R1.2 | Delete | . |
| L5.1 to L1.K and R2.1 to R1.3 | Insert | 0 |
| L5.1 to L1.K and R5.1 to R1.K | Enter | Enter |

FIG. 17 is a table showing symbol keys that may be accessed using a left hand while connection R3.1 to R1.K, corresponding to a ‘Sym’ key 223, is sustained using a right hand. The symbol keys shown in FIG. 17 do not necessarily include all of the symbols typically available on a keyboard using a shift key and a top line of numbers, because many symbols are already available through other connections. The hashed regions of FIG. 17 correspond to connections without defined outputs. Additional symbols or functions may be programmed to be accessible with the connections. Table 5 below provides much of the same information illustrated in FIG. 17 in a more typically formatted table:

TABLE 5
Symbol Keys

| Connections | Key |
|---|---|
| R3.1 to R1.K and L5.2 to L1.1 | ! |
| R3.1 to R1.K and L4.2 to L1.1 | @ |
| R3.1 to R1.K and L3.2 to L1.1 | # |
| R3.1 to R1.K and L5.1 to L1.1 | $ |
| R3.1 to R1.K and L4.1 to L1.1 | % |
| R3.1 to R1.K and L3.1 to L1.1 | \hat{ } |
| R3.1 to R1.K and L2.1 to L1.1 | & |
| R3.1 to R1.K and L5.1 to L1.3 | = |
| R3.1 to R1.K and L4.1 to L1.3 | * |

FIG. 18 is a table showing numbered function keys that may be accessed using a right hand while a ‘Fn’ key 225 is access through connection ‘L5.1 to L1.3’ and sustained using a left hand. These function keys are often made available on a top row of a traditional keyboard and may have defined functions specific to various computer applications. Table 6 below provides much of the same information illustrated in FIG. 18 in a more typically formatted table:

TABLE 6
Function Keys

| Connections | Key |
|---|---|
| L5.1 to L1.3 and R2.3 to R1.1 | Escape |
| L5.1 to L1.3 and R2.2 to R1.1 | F1 |
| L5.1 to L1.3 and R3.2 to R1.1 | F2 |
| L5.1 to L1.3 and R4.2 to R1.1 | F3 |
| L5.1 to L1.3 and R5.2 to R1.1 | F4 |
| L5.1 to L1.3 and R2.1 to R1.1 | F5 |
| L5.1 to L1.3 and R3.1 to R1.1 | F6 |
| L5.1 to L1.3 and R4.1 to R1.1 | F7 |
| L5.1 to L1.3 and R5.1 to R1.2 | F8 |
| L5.1 to L1.3 and R2.1 to R1.2 | F9 |
| L5.1 to L1.3 and R3.1 to R1.2 | F10 |
| L5.1 to L1.3 and R4.1 to R1.2 | F11 |
| L5.1 to L1.3 and R5.1 to R1.2 | F12 |

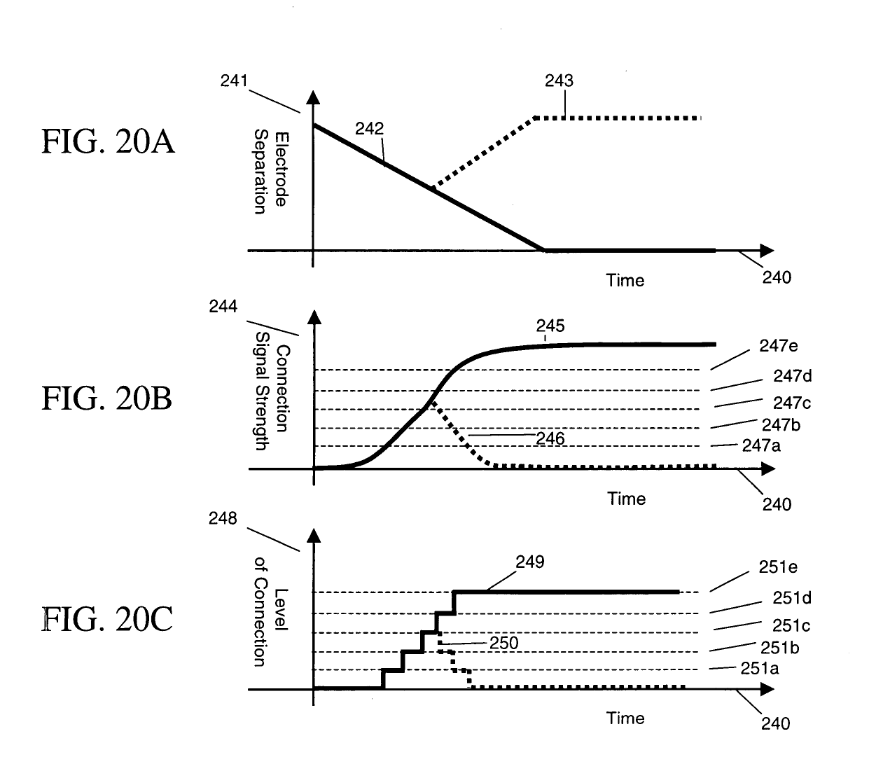

In an alternate embodiment, configurations of an electrical connection network between body attached electrodes may be used as a human interface for a musical instrument. FIG. 19 provides tables to demonstrate how connections between electrodes may be used to control output pitch of a musical device in an embodiment designed to simulate a pitch control from a typical valved brass instrument. The table of FIG. 19, shows accessible pitches in section 230 using scientific pitch notation. Each column of section 230 corresponds to a different overtone labeled in section 231. Electrode configurations on the left hand may be used to select musical overtones. Columns of sections 230 and 231 corresponding to eight overtones are provided with labels 232 indicating associated electrode connections. Durations of sound outputs of the device may be limited to times during which left-handed connections are sustained.

Pitches associated with the selected overtone may be lowered by right-hand electrode connections in analogy to opening and closing valves on a typical valved brass instrument. The rows of section 230 correspond to various pitch-lowering intervals accessible with different simulated valve combinations. The pitch-lowering intervals for each row are indicated in section 233.

Each of the rows of sections 230 and 233 correspond to pitch-lowering intervals selected by combinations of connections indicated in the rows section 234. Columns of section 234 correspond to connections indicated by labels 235. An ‘X’ in a cell of section 234 indicates that a connection corresponding to the column of that cell must be established to generate the pitch-lowering corresponding to the row of that cell. An ‘O’ in a cell of section 234 indicates that a connection corresponding to the column of that cell must not be established to generate the pitch-lowering corresponding to the row of that cell.

By connected an electrode on a right index finger (R2.1) to an electrode on a right thumb (R1.1) a pitch is lowered by 1 whole steps (or two semitones) relative to a selected overtone; A connection between an electrode on a middle finger (R3.1) and an electrode on a right thumb (R1.1) may be used to lower a pitch by a half-step ( or one semitone) relative to an overtone pitch; A connection between an electrode on a right ring finger (R4.1) and an electrode on a right thumb (R1.1) may be used to lower a pitch by 1.5 musical whole steps (or three semitones) relative to a selected overtone; and a connection between a right little finger (R5.1) and a thumb (R1.1) may be used to lower the musical pitch by 2.5 whole steps (or 5 semitones) relative to a selected overtone. As in a brass instrument there may be several combinations of overtones and valve positions that will provide the same pitch. Combinations of simultaneous connections provide pitch lowering between 0 and 5.5 whole steps as shown in sections 233 and 234 of FIG. 19.

In this embodiment, it may be desirable to enlarge an electrode R1.1 attached to a right thumb so that the multi-connection connections between a thumb and multiple fingers may be more easily accomplished.

It should be readily apparent to one skilled in the art that mappings from electrode positions to pitches that correspond to fingerings for other instruments can easily be devised. Furthermore, additional connections may be used to alter the pitch, tone, dynamics or articulation of notes.

In some embodiments, it may be desirable to provide connection strengths between electrodes instead of an on-off state for each connection. For capacitive coupling connections, inductive connections, and pressure sensitive conductive connections, the sensed signal on an electrode will depend on the distance of separation between the sensed electrode and the probed electrode. The level of connections between electrodes may be used, for example, to control the volume of sound produced for a musical device. The level of a connection for other applications may be used to control cursor positioning or be used for other continuous or variable computer inputs.

FIG. 20A shows graphs of electrode separation 241 as a function of time 240. A continuous line 242 corresponds to electrodes being brought together to a minimum separation distance; a dashed line 243 corresponds to electrodes being separated after initially bringing brought closer together.

FIG. 20B shows graphs of connection signal strength 244 as a function of time 240 as an electrode separation distance is reduced. A solid line 245 graph of connection signal strength indicates a signal strength that may correspond to electrode separation 242 (shown in FIG. 20A); and dotted line 246 graph of connection strength may correspond to graph of electrode separation 243 (also shown in FIG. 20A). A plurality of signal threshold levels 247a-247e may be provided for comparison against signal strengths.

FIG. 20C shows graphs of the digitized signal strength or levels of connection 248 as a function of time 240 for output levels of connection 251a-251e. A solid line 249 shows a level of connection as a function of time 240 corresponding to a graph of signal connection 245 (shown in FIG. 20B); and dotted line 250 graph of connection strength may correspond to graph of signal strength separation 246 (also shown in FIG. 20B). Each signal threshold level 247a-247e of FIG. 20B corresponds to an output level of connection 251a-251e. An output level of connection may be selected to based on an output level corresponding to the highest signal threshold exceeded by a signal strength at any given time. A connection may have a zero level of connection (not connected) or have an output level of connection corresponding to a threshold signal level. In some simple embodiments only one threshold signal level and one level of connection may be required, but some applications may require a plurality of available levels of connections.

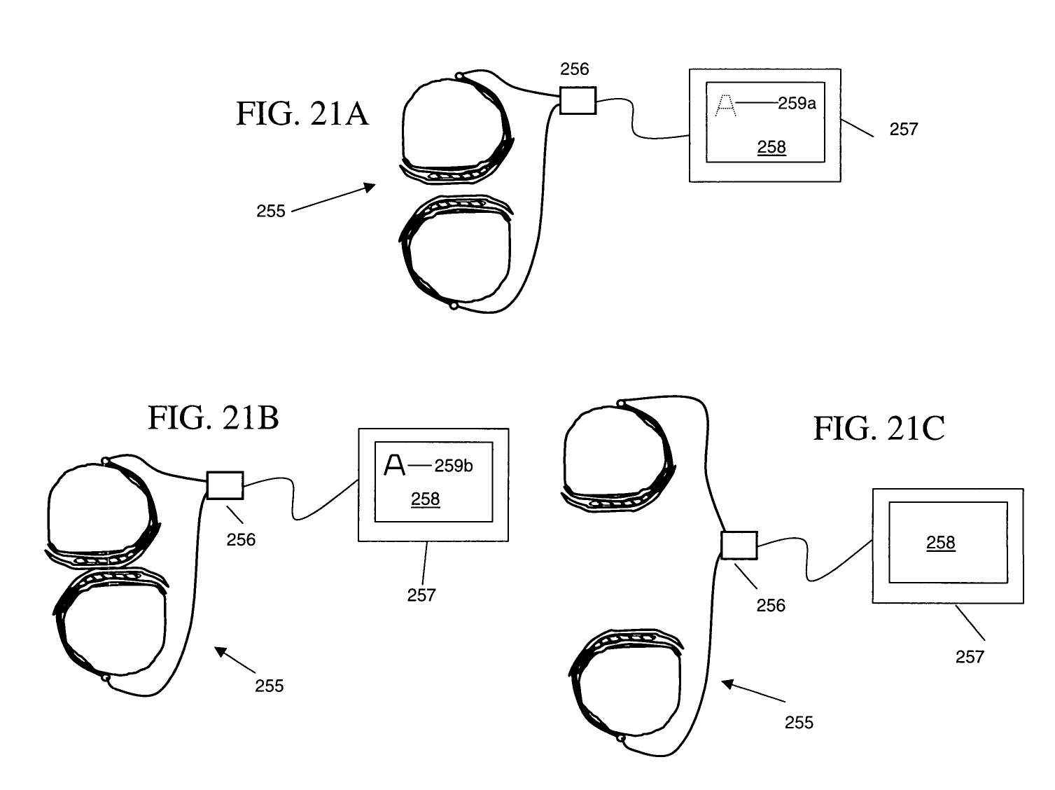

In keyboard-like embodiments a level of connection may be used to provide a user feedback on key entries which are about to be accepted, before a full level of connection is established. An example of such a feedback method may be illustrated using FIGS. 20A-20C and FIGS. 21A-21C.

For example, as a user moves two electrodes together as shown in 242 (FIG. 20A), a connection signal strength between the electrodes is increased and a digitized level of connection 249 (FIG. 20C) is increased.

As a digitized level of connection surpasses some threshold value, for example 251b (FIG. 20C) a user receives feedback about the connection that is being established. For example, perhaps, a connection corresponds to entering the letter ‘A’ on for a personal computer.

If a user intends to enter the letter ‘A’, the user may continue to reduce the separation between electrodes, increasing the sensed signal strength and level of connection, until a full connection is established and the letter ‘A’ is entered as in input to the computer.

However, if the user did not intend to enter the letter ‘A’, but really intended to enter a different key, the user could increase separation (243 of FIG. 20A) between electrodes, reducing signal strengths (246 of FIG. 20B) and level of connection (250 of FIG. 20C), until a connection is disconnected. A feedback software system would then delete the original provisional input (e.g. ‘A’).

For entering text without traditional keys, and based on connection combinations, this feedback feature is very useful. This is an especially useful function while learning connections that correspond to different keys.

FIG. 21A shows system 255 of a cross-section of two fingers with body attached electrodes approaching each other, an output generator 256, processing levels of connection, and a visual output device 257. A visual output device 257 contains a display 258 which presents final and provisional results corresponding to entered keys. A provisional response may be a display of text in a temporary font style 259a, or results displayed in a provisional window separate from a window corresponding to an application receiving keyed input.

After a provisional display of text 259a has been presented in display 258, a user may continue to close the separation between electrodes, as illustrated in FIG. 21B, until a full connection is established, so that a provisional result is made final. Making a result final may correspond to a temporary font style changing to a final font style 259b, or text appearing in a provisional windows being transferred into an applications window.

If a user, while observing a provisional result, doesn't intend to have a corresponding final result, the user may instead choose to separate the user's fingers, as illustrated in FIG. 21C. An output-generating device may provide signals to eliminate the provisional result as illustrated by the absence of text in the display 258 of FIG. 21C.

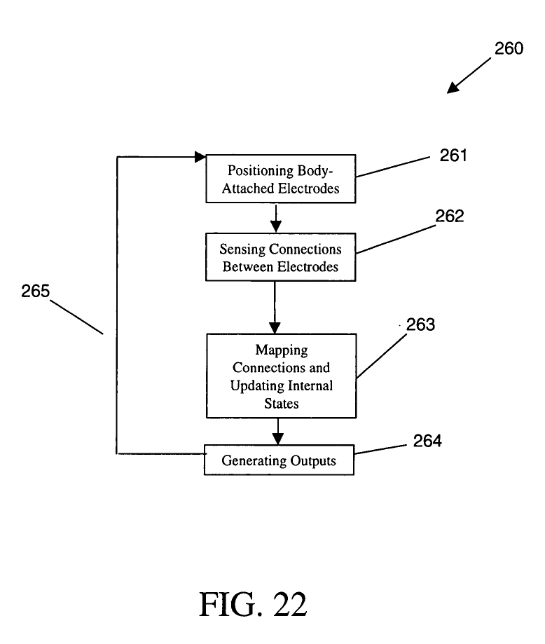

FIG. 22 illustrates components of a method for generating outputs, 260, by positioning body-attached electrodes. A first procedural element may be to position body-attached electrodes 261. This may involve a user of the device moving their fingers or other body parts. A second procedural element may involve sensing connections between electrodes 262, based on relative positions of electrodes. Sensed connection strengths between electrodes may be used to execute a procedural element of mapping connections and updating internal states 263 of the device. Internal states may be used, for example, to keep track of different input modes and use of synchronized or multi-connect connections for generating or selecting keys. Sensed connection strengths and internal states of the device may be used to in a procedural element of generating outputs 264. This cycle may be repeated continuously by closing loop 265 back to a first procedural element 261.

It will be understood by one skilled in the art, that the order of execution of the procedural elements of method 260 may be performed in different sequences and functions of the steps described may be intermingled but still perform the basic procedural elements as described. For example, the positioning of body parts 261 may occur continuously and not as a single step.

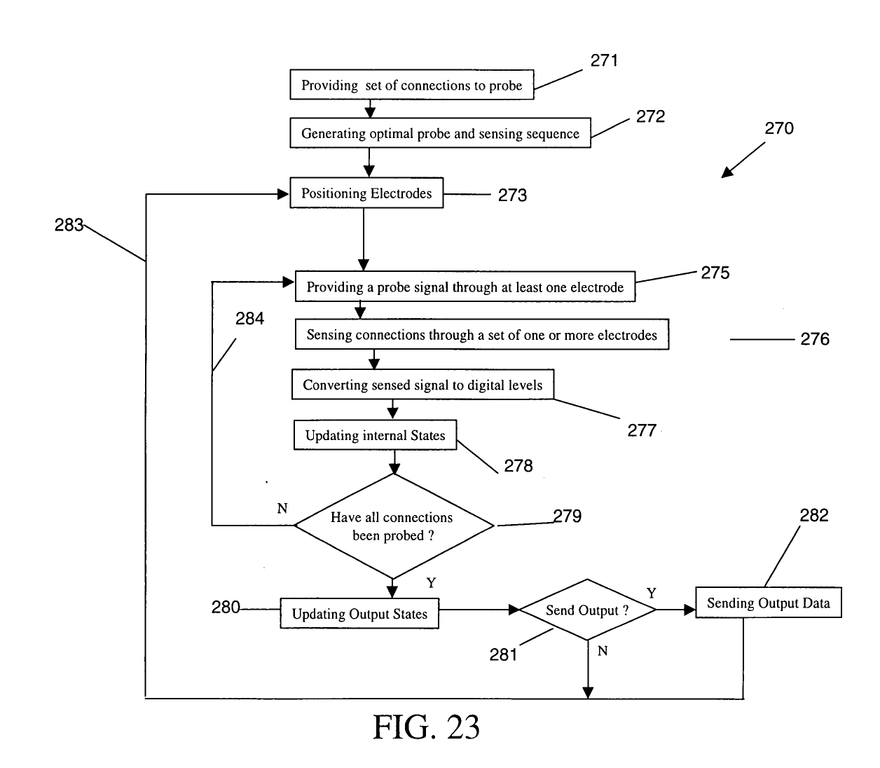

FIG. 23 provides a sequence of steps for one embodiment of a method for sensing connection strengths 270. Given a specific application with a set of body-attached electrodes a first procedural element may include providing a set of connections to Probe, 271. Given expected occurrences of connections, clustering of electrodes, or connections that need to be sensed, a second procedural element may include generating an optimal probe and sensing sequence, 272. This sequence may be a sequence for probing and sensing specific electrodes. Such a sequence may include an ordering and selection of precisely which electrodes to probe and a corresponding set of electrodes to sense. Typically, not all-possible electrode connections would need to be sensed and considerable performance enhancements should be gained by sensing only required connections needed for a specific application.

A continuous loop 283 within the method of 270 may be defined in which a first procedural element may consist of Positioning Electrodes 273. Though it is understood that movement of electrodes may be continuous during execution of method 270, the effect may be consolidated into a single repeated distinct step. A next procedural element for sensing connection strengths may include providing a probe signal through at least one electrode, 275. The selection of at least one electrode may be based on an optimal probe sequence generated in procedural element 272 and may be updated on each cycle of loop 284. While a probe signal is provided to at least one electrode, voltages or currents on a set of other electrodes may be sensed so that a procedural element of sensing connections through a set of one or more electrodes, procedural element 276, may be accomplished. Given sensed voltages or currents corresponding to sensed connections, a procedural element of converting sensed signals to digital levels, 277, may be performed. Procedural element 277 may be as simple as assigning connections a strength of zero or one; however, a larger set of connection strengths may be useful for some applications. Procedural element 277 may be performed using standard amplifiers and electronic analog-to-digital converters. Once connection levels have been established, internal states may be updated in procedural element 278. Procedural element 278 may include updating data, based on an optimal probe and sensing sequence, for selecting which electrodes to probe next. For example, based on the anatomy of a hand, a sensed connection ‘R1.1 to R1.K’ may make it unnecessary to probe for a connection ‘R1.1 to R2. 1’ because both simultaneous connections may are not easily established.

Once a procedural element 278 has been completed, logic may be performed to decide if all required connections have been probed. If the result of this logical step, 279, is that there are more connections that need to be probed, the next set of at least one electrode may be selected for probing and procedural element 275 may be executed to continue loop 284.

If procedural element 279 returns a result that all required connections, generated in procedural element 271 and possibly refined in procedural element 278, have been probed and sensed, then a set of output states may be updated in a procedural element 280. Output states may keep track of sequences of connection events and connection levels that must occur before an output is sent. Additionally, output states may be used to for recording and determining a composite key level of connection from multiple electrode levels of connections when multiple connections are required to select a single key. A next step, 281, involves logic, that may involve output states, to determine if an output should be generated. If an output should be generated, then a step of Sending Output Data, 282, may be executed. Whether data is outputted or not, new electrode positions may be sensed by closing a procedural loop 283 and executing step 273.

It will be understood by one skilled in the art, that the order of execution of the procedural elements of method 270 may be performed in different sequences and functions of the steps described may be intermingled but still perform the basic steps as described. For example, the positioning electrodes procedural element, 273, may occur continuously and not as a single step.

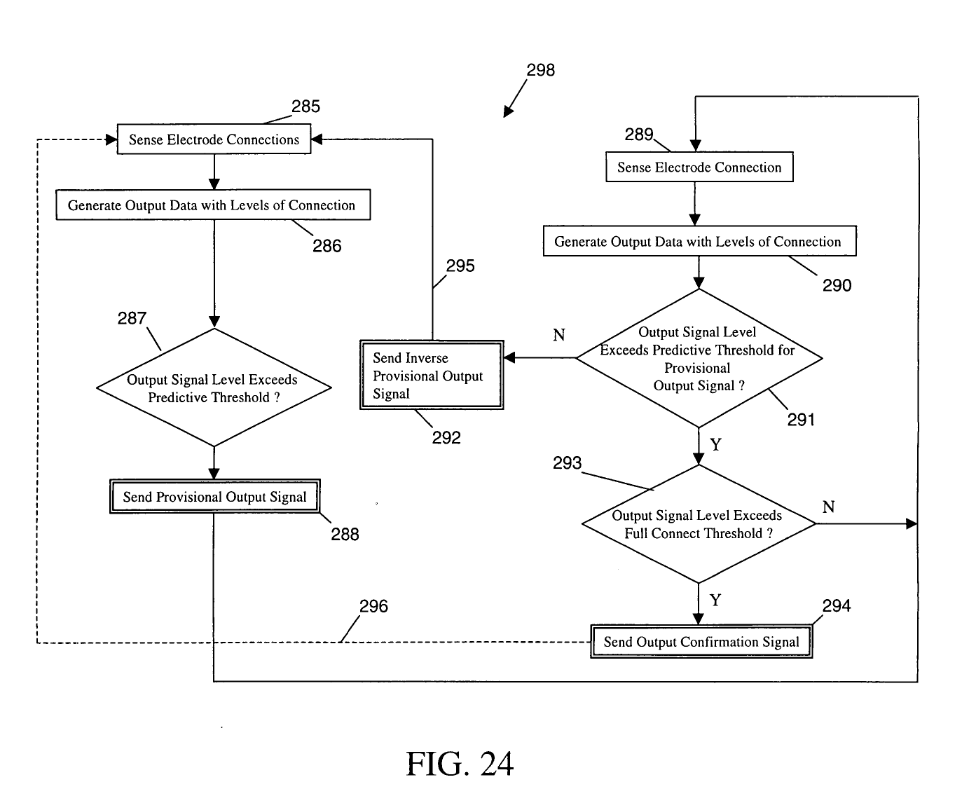

FIG. 24 illustrates the procedural elements of a method 298, in some embodiments, for providing user feedback to allow a user to alter provisional inputs. A first procedural element, 285, is to sense electrode connections. A second procedural element, 286, consisting of generating output data with levels of connection. Electrode levels of connection may be used identify a specific output key and to generate an associated output or key level of connection.

Step 287 includes the determination of whether levels of connection, or a function thereof, exceed some predictive threshold. If levels of connection exceed a predictive threshold, provisional output data may be generated and sent in a step 288. A device receiving the provisional output data may provide a user with predictive feedback before corresponding final output data is produced.

Once provisional data has been sent, a procedural element 289 to sense electrode connections may be performed. A next step, 290, consisting of generating output data with levels of connection may be executed. A logical step 291, is a step for determining if the sensed connections (from step 289) still exceed a predictive threshold. If output signals do not exceed a predictive threshold, or if output signals differ from a stored provisional output, a provisional output generated in the most previous execution of step 288 is retracted or an inverse signal is sent to reverse the effect of the provisional signal in a step 292. Once a provisional output is retracted, the procedure may close a loop 295 and again sense electrode connections in a first step 285. The predictive threshold is step 291 may be made lower than the predictive threshold of step 287 to avoid premature retraction of a provisional output.

If output data generated in step 290 is consistent with the provisional output and if it is determined in step 291 that a key level of connection exceeds a predictive level of connection, a logical step 293 may be performed to see if levels of connection further exceed a full-connection threshold. If the levels of connection exceeds a full-connection threshold, then an output confirmation of the provisional data may be generated and the process may begin again starting with step 285 after closing a loop 296. If, in step 293, it is determined that the key level of connection doesn't exceed a full-connection threshold, provisional output may be maintained as provisional, electrode levels of connection may be sensed again in step 289.

It will be understood by one skilled in the art, that the order of execution of the steps of method 298 may be performed in different sequences, and functions of the steps described may be intermingled but still perform the basic steps as described.

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the invention are desired to be protected.

1. A human-machine interface system including:
two or more body-attached electrodes, where at least one of the electrodes is insulated, where said body-attached electrodes may be coupled to form a reconfigurable electrical connection network; and
at least one output-generating element.

2. The system of claim 1, where said output generating element unit comprising at least one electrical connection sensor for sensing electrical connections between two or more of said body-attached electrodes.

3. The system of claim 1, additionally including at least one electrode that may be coupled with at least one of said body-attached electrodes as an additional part of said reconfigurable electrical connection network.

4. The system of claim 1, additionally including an electrode array.

5. The system of claim 1, where said output element is used to generate input data for a computer.

6. The system of claim 5, where said input data includes keyed data.

7. The system of claim 5, where said output element generates transmissions of said input data through wireless communications.

8. The system of claim 7, where said transmissions are encrypted.

9. The system of claim 1, where said output element is used to generate data for music generation.

10. The system of claim 1, where said reconfigurable electrode connection network is reconfigurably connected through at least one capacitive coupling connection between said body-attached electrodes.

11. The system of claim 1, where said reconfigurable electrode connection network is reconfigurably connected through at least one conductive coupling connection between said body-attached electrodes.

12. The system of claim 1, where said reconfigurable electrode connection network is reconfigurably connected through at least one inductive coupling connection between said body-attached electrodes.

13. The system of claim 1, where at least two said body-attached electrodes are attached to at least one hand.

14. The system of claim 2, where said electrical connection sensor is capable of sensing electrical connections between body-attached electrodes from or between both hands.

15. The system of claim 2, where said electrical connection sensor is capable of sensing simultaneous electrical connections between more than two said body-attached electrodes.

16. The system of claim 2, where said electrical connection sensor is capable of sensing multi-connect electrical connections between more than two said body-attached electrodes.

17. The system of claim 1, where said output generating element detects one or more levels of connection.

18. The system of claim 1, where levels of connection are used to provide predictive feedback to a user.

19. A human-machine interface system comprising:
a plurality of hand-attached electrodes, where said hand-attached electrodes may be coupled to form a reconfigurable electrical connection network, where at least one of the plurality of electrodes is insulated; and
at least one output generating element, whereby the said electrical output configuration data may be outputted to an external system.

20. The system of claim 19, where said hand-attached electrodes are attached to said at least one hand using a glove.

21. The system of claim 19, where said hand-attached electrodes are attached to said at least one hand using a support system.

22. A method for generating data comprising:
(a) establishing one or more electrical connections between two or more body-attached electrodes, where at least one of the electrodes is insulated;
(b) sensing said electrical connections with an output generator; and
(c) generating data corresponding to said electrical connections.

23. The method of claim 22, where step (a) further comprises the step of:
(a1) establishing one or more electrical connections using capacitive coupling.

24. The method of claim 22, where step (a) further comprises the step of:
(a1) establishing one or more electrical connections using conductive coupling.

25. The method of claim 22, where step (a) further comprises the step of:
(a1) establishing one or more electrical connections using inductive coupling.

26. The method of claim 22, where step (b) further comprises the step of:
(b1) probing a probed set of at least one electrode with an electrical pulse;
(b2) sensing a sensed set of at least one electrode for electrical pulses;
(b3) converting sensed electrical pulses to digital levels;
(b4) updating states;
(b5) changing said probed set of at least one electrode;
(b6) outputting data based on states; and
(b7) repeating said probing, said sensing, and said converting, said updating, said changing and said outputting.

27. The method of claim 22, where step (c) further comprises the step of:
(c1) converting sensed signals to digital levels of connection.

28. The method of claim 27, where step (c) further comprises:
(c2) sending provisional data when a level of connection exceeds a predictive threshold;
(c3) retracting established provisional data, when a level of connection fails to exceed a sustaining predictive threshold; and
(c4) confirming provisional data, when a level of connection exceeds a full-connection threshold.
